(19) United States
(12) Patent Application Publication
(10) Pub. No.: US 2024/0246023 A1
(43) Pub. Date: Jul. 25, 2024

(54) SMALL MODULAR NUCLEAR REACTOR INTEGRATED ENERGY SYSTEMS FOR CAPTURING ATMOSPHERIC CARBON DIOXIDE USING SODIUM HYDROXIDE

(71) Applicant: NuScale Power, LLC, Corvallis, OR (US)

(72) Inventors: Francis Y. Tsang, Bellingham, WA (US); José N. Reyes, JR., Corvallis, OR (US); Luis DePavia, Corvallis, OR (US)

(21) Appl. No.: 18/395,441

(22) Filed: Dec. 22, 2023

Related U.S. Application Data
(60) Provisional application No. 63/439,062, filed on Jan. 13, 2023.
(60) Provisional application No. 63/439,067, filed on Jan. 13, 2023.
(60) Provisional application No. 63/493,049, filed on Mar. 30, 2023.

(51) Int. Cl. B01D 53/14; B01D 53/18; B01D 53/62; B01D 53/78; B01D 53/96; B01J 6/00; B01J 19/24; C01B 3/02; C01B 32/50; C01D 1/02; C02F 1/44; C25B 1/46; F01K 3/18

(52) U.S. Cl. CPC B01D 53/1425; B01D 53/1475; B01D 53/1493; B01D 53/18; B01D 53/62; B01D 53/78; B01D 53/96; B01J 6/008; B01J 19/245; C01B 3/02; C01B 32/50; C01D 1/02; C02F 1/441; C25B 1/46; F01K 3/181; B01D 2251/304; B01D 2251/604; B01D 2257/504; B01D 2258/06; C02F 2103/08

(57) ABSTRACT

Integrated Energy Systems (IESs), such as for use in capturing atmospheric carbon dioxide, and associated devices and methods are described herein. A representative IES can include a power plant system having multiple modular nuclear reactors, a desalination plant, a brine processing plant, and a direct air capture plant. The nuclear reactors can generate electricity and/or steam for use by the desalination plant and the direct air capture plant. The desalination plant can use the electricity and/or steam to produce brine from seawater or brackish water. The brine processing plant can receive the brine from the desalination plant and process the brine to produce sodium hydroxide. The direct air capture plant can use the sodium hydroxide as a liquid sorbent in a direct air capture process to capture carbon dioxide from atmospheric air.

### CROSS-REFERENCE TO RELATED APPLICATIONS

This application claims the benefit of U.S. Provisional Patent Application No. 63/439,062, filed Jan. 13, 2023, and titled “SMALL MODULAR NUCLEAR REACTOR INTEGRATED ENERGY SYSTEMS FOR DESALINATION APPLICATIONS, AND ASSOCIATED DEVICES AND METHODS,” U.S. Provisional Patent Application No. 63/439,067, filed Jan. 13, 2023, and titled “SMALL MODULAR NUCLEAR REACTOR INTEGRATED ENERGY SYSTEMS FOR CAPTURING ATMOSPHERIC CARBON DIOXIDE (CO2), AND ASSOCIATED DEVICES AND METHODS,” and U.S. Provisional Patent Application No. 63/493,049, filed Mar. 30, 2023, and titled “SYSTEMS, METHODS, AND DEVICES FOR CAPTURING CARBON DIOXIDE FROM THE ATMOSPHERE USING SODIUM HYDROXIDE,” each of which is incorporated herein by reference in its entirety.

### TECHNICAL FIELD

The present technology is directed to Integrated Energy Systems (IESs) for capturing atmospheric carbon dioxide and, more particularly, to IESs configured to generate electricity and steam from a nuclear reactor plant for use in producing sodium hydroxide for use as a liquid sorbent in Direct Air Capture (DAC) processes.

### BACKGROUND

According to the Intergovernmental Panel on Climate Change (IPCC), the accumulation of carbon dioxide (CO₂) in the atmosphere is the main driver of global warming. Current trends project that in the year 2100 the atmospheric CO₂ concentration will be between 530-980 parts per million (ppm) possibly doubling the current level of 410 ppm and far higher than the preindustrial level of 280 ppm. The rising CO₂ concentration could cause a global mean temperature change from 1990 to 2100 of 1.4-6.1 degrees Celsius. To prevent a global catastrophe, CO₂ concentrations in the atmosphere—which at this point are essentially unavoidable—are expected to require active removal of CO₂. This will require technologies to capture and permanently remove CO₂ from the air.

The concept of capturing CO₂ from air was first introduced for climate change mitigation in 1999. In the following decade, researchers debated whether direct air capture (DAC) is an important and viable option for reducing greenhouse gas levels. Central to most direct air capture technologies is the use of sorbent materials. Since CO₂ is very dilute in the air, any process for capturing CO₂ must avoid spending significant amounts of energy and utilizing additional materials on processing bulk air for CO₂ removal, thus making it difficult to heat, cool, or compress the air. Sorbents bind CO₂ from the air without energy input. Energy consumption is deferred to a more favorable process stage-when higher concentrations of CO₂ are removed from the sorbent.

The primary industrial developers of direct air capture today are Carbon Engineering (Canada), Climeworks (Switzerland), and Global Thermostat (USA). According to the International Energy Agency, as of 2019 there are 15 operational direct air capture plants worldwide. In the United States alone, there are plants in advanced development with the potential to capture up to one megaton of CO₂ per year.

However, conventional direct air capture techniques still require large energy inputs to capture CO₂. For example, it can take 8.81 gigajoules (e.g., 2.45 megawatt hours) to capture one megaton of CO₂.

### BRIEF DESCRIPTION OF THE DRAWINGS

Many aspects of the present technology can be better understood with reference to the following drawings. The components in the drawings are not necessarily to scale. Instead, emphasis is placed on clearly illustrating the principles of the present technology.

FIG. 1 is a partially schematic, partially cross-sectional view of a small modular reactor system in accordance with embodiments of the present technology.

FIG. 2 is a partially schematic, partially cross-sectional view of a small modular reactor system in accordance with additional embodiments of the present technology.

FIG. 3 is a schematic view of a nuclear power plant system including multiple small modular reactor systems in accordance with embodiments of the present technology.

FIG. 4 is a schematic diagram of an integrated energy system including the power plant system of FIG. 3 in accordance with embodiments of the present technology.

FIG. 5 is a schematic diagram of a membrane cell for carrying out the Chlor-Alkali Membrane process via the electrolysis of aqueous sodium chloride in accordance with the prior art.

FIG. 6 is a schematic diagram of a direct air capture plant and a post-processing plant in accordance with the prior art.

FIG. 7 is a schematic diagram of a direct air capture plant and a post-processing plant of the integrated energy system of FIG. 4 in accordance with embodiments of the present technology.

FIG. 8 is a schematic diagram of an integrated energy system including the power plant system of FIG. 3 in accordance with additional embodiments of the present technology.

FIG. 9 is a schematic diagram of a direct air capture plant of the integrated energy system of FIG. 8 configured to utilize formic acid in a direct air capture process in accordance with embodiments of the present technology.

FIG. 10 is a schematic diagram of a chemical processing plant of the integrated energy system of FIG. 8 configured to utilize sodium formate produced by the direct air capture plant of FIG. 9 to produce hydrogen in accordance with embodiments of the present technology.

FIG. 11 is a schematic diagram of a direct air capture plant of the integrated energy system of FIG. 8 configured to utilize acetic acid in a direct air capture process in accordance with embodiments of the present technology.

FIG. 12 is a schematic diagram of a chemical processing plant of the integrated energy system of FIG. 8 configured to utilize sodium acetate produced by the direct air capture plant of FIG. 11 to produce hydrogen in accordance with embodiments of the present technology.

### DETAILED DESCRIPTION

Aspects of the present technology are directed generally toward integrated energy systems, such as for use in capturing atmospheric carbon dioxide. The integrated energy systems of the present technology can have few or no carbon emissions and, in fact, can be carbon negative by capturing carbon dioxide from the atmosphere. In some embodiments, an integrated energy system includes a power plant system having multiple small modular nuclear reactors (SMRs) specifically configured to operate in unison to support a direct air capture process. The power plant system can be of the type manufactured by NuScale Power of Portland, Oregon, such as the NuScale Power Module™ (NPM), a 250-megawatt thermal (MWt) integral pressurized water reactor (PWR) that employs gravity-driven natural circulation of the primary coolant for both normal operation and shutdown mode. The NPM, including containment, is fully factory-built and shipped to the plant site by truck, rail, or barge. NuScale's flagship VOYGR-12 power plant design can accommodate up to 12 NPMs, resulting in a total gross output of 924 megawatts electric (MWe). Other configurations include smaller power plant solutions, such as the four-module VOYGR-4 (308 MWe) and the six-module VOYGR-6 (462 MWe).

Accordingly, in some embodiments the power plant system includes a plurality of nuclear reactors and is configured to produce a steam output and an electrical output. The integrated energy system can further include a desalination plant, a brine processing plant, and a direct air capture plant. The desalination plant can be positioned to receive seawater and/or brackish water, and can be coupled (e.g., operably coupled) to the power plant system to receive a first portion of the steam output and/or a first portion of the electrical output. The desalination plant can be configured to use the first portion of the steam output and/or the first portion of the electrical output to process the seawater or brackish water to produce brine and clean water. The brine processing plant can be coupled to the desalination plant to receive the brine from the desalination plant, and can be configured to process the brine to produce sodium hydroxide. The direct air capture plant can be (i) coupled to the desalination plant to receive the sodium hydroxide from the brine processing plant and (ii) coupled to the power plant system to receive a second portion of the steam output and/or a second portion of the electrical output from the power plant system. The direct air capture plant can be configured to utilize the sodium hydroxide and the second portion of the steam output and/or the second portion of the electrical output in a direct air capture process to capture carbon dioxide from atmospheric air. For example, the direct air capture plant can use the sodium hydroxide as a liquid sorbent to capture the carbon dioxide from the atmospheric air.

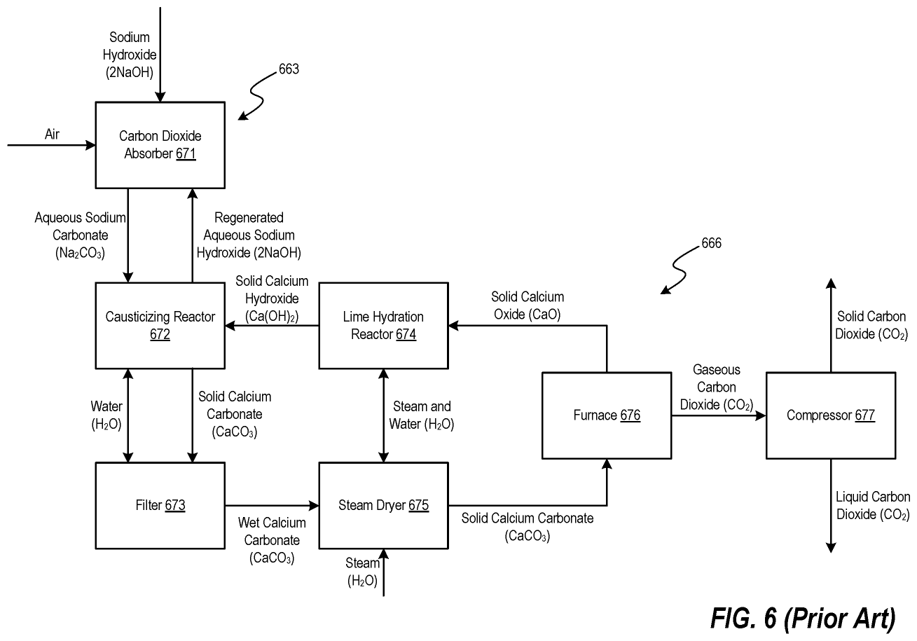

In some embodiments, the direct air capture plant carries out a direct air capture process that does not use calcium oxide to regenerate the liquid sorbent sodium hydroxide (e.g., as compared to the prior art process shown in FIG. 6). For example, the direct air capture can do so by introducing an evaporation step and a thermal decomposition step to release the captured carbon dioxide and regenerate an intermediate compound, sodium oxide, which can be used to regenerate the liquid sorbent via hydrolysis. More specifically, the direct air capture plant can comprise an air contactor, an evaporator, a thermal decomposition chamber, a sodium oxide reaction chamber, and a compressor. The air contactor can be configured to react the atmospheric air with the sodium hydroxide to produce a solution of sodium carbonate and sodium hydroxide. The evaporator can be coupled to the air contactor to receive the solution of sodium carbonate and sodium hydroxide, and can be configured to heat the solution of sodium carbonate and sodium hydroxide to produce solid sodium carbonate. The thermal decomposition chamber can be coupled to the evaporator to receive the solid sodium carbonate, and can be configured to heat the solid sodium carbonate to produce gaseous carbon dioxide and sodium oxide. The compressor can be coupled to the thermal decomposition chamber to receive the gaseous carbon dioxide, and can be configured to compress the gaseous carbon dioxide for storage, sequestration, or industrial use in such a manner that the carbon dioxide is effectively removed from the atmosphere. The sodium oxide reaction chamber can be coupled to the thermal decomposition chamber to receive the sodium oxide, and can be configured to react the sodium oxide with water to regenerate sodium hydroxide. The air contactor can be coupled to the sodium oxide reaction chamber to receive the regenerated sodium hydroxide, and can further be configured to react the atmospheric air with the regenerated sodium hydroxide to produce the solution of sodium carbonate and sodium hydroxide.

In some embodiments, the direct air capture plant carries out a direct air capture process that uses a carboxylic acid to react with the solution of sodium carbonate and sodium hydroxide produced by the air contactor to produce gaseous carbon dioxide and a chemical byproduct. The carboxylic acid can be formic acid and the chemical byproduct can be sodium formate. In such embodiments, the integrated energy system can further comprise a sodium formate processing plant coupled to the direct air capture plant to receive the sodium formate from the direct air capture plant and configured to process the sodium formate to produce hydrogen (e.g., as an energy carrier). The carboxylic acid can be acetic acid (e.g., vinegar) and the chemical byproduct can be sodium acetate. In such embodiments, the integrated energy system can further comprise a sodium acetate processing plant coupled to the direct air capture plant to receive the sodium acetate from the direct air capture plant and configured to process the sodium acetate to produce hydrogen. In these and other embodiments, the hydrogen can be routed to one or more industrial processes and/or used to generate electricity. For example, the hydrogen can be utilized in a hydrogen fuel cell to regenerate electricity.

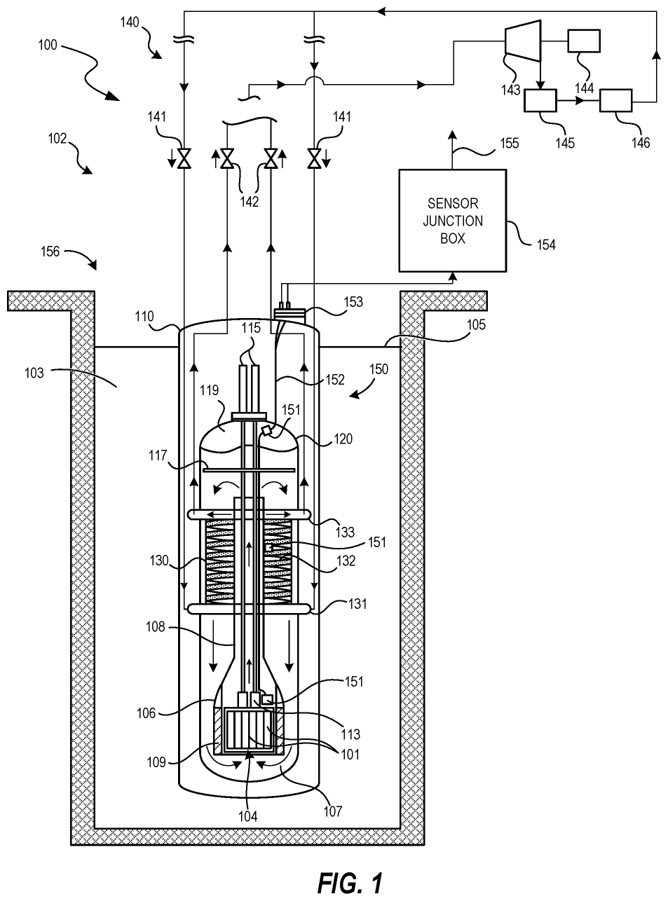

Certain details are set forth in the following description and in FIGS. 1-12 to provide a thorough understanding of various embodiments of the present technology. In other instances, well-known structures, materials, operations, and/or systems often associated with nuclear reactors, power plant systems, integrated energy systems, chemical production plants, industrial process plants, direct air capture plants, direct air capture processes, brine processing, and the like, are not shown or described in detail in the following disclosure to avoid unnecessarily obscuring the description of the various embodiments of the technology. Those of ordinary skill in the art will recognize, however, that the present technology can be practiced without one or more of the details set forth herein, and/or with other structures, methods, components, and so forth. The terminology used below is to be interpreted in its broadest reasonable manner, even though it is being used in conjunction with a detailed description of certain examples of embodiments of the technology.

The accompanying Figures depict embodiments of the present technology and are not intended to limit its scope unless expressly indicated. The sizes of various depicted elements are not necessarily drawn to scale, and these various elements may be enlarged to improve legibility. Component details may be abstracted in the Figures to exclude details such as position of components and certain precise connections between such components when such details are unnecessary for a complete understanding of how to make and use the present technology. Many of the details, dimensions, angles and other features shown in the Figures are merely illustrative of particular embodiments of the disclosure. Accordingly, other embodiments can have other details, dimensions, angles and features without departing from the present technology. In addition, those of ordinary skill in the art will appreciate that further embodiments of the present technology can be practiced without several of the details described below.

To the extent any materials incorporated herein by reference conflict with the present disclosure, the present disclosure controls. The headings provided herein are for convenience only and should not be construed as limiting the subject matter disclosed.

### I. Select Embodiments of Nuclear Reactor Power Conversion Systems

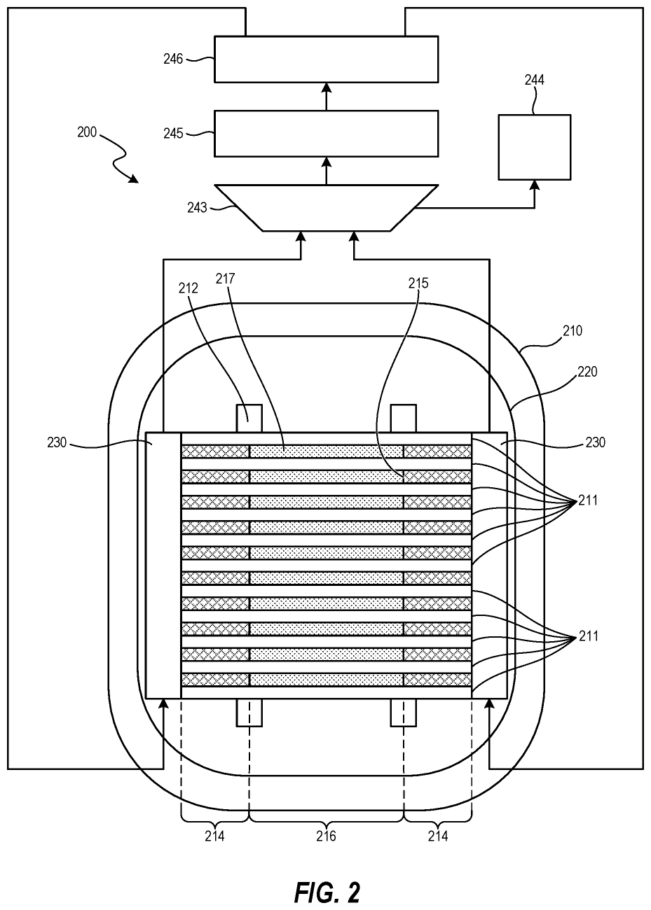

FIGS. 1 and 2 illustrate representative nuclear reactors that may be included in embodiments of the present technology. FIG. 1 is a partially schematic, partially cross-sectional view of a nuclear reactor system 100 configured in accordance with embodiments of the present technology. The system 100 can include a power module 102 having a reactor core 104 in which a controlled nuclear reaction takes place. Accordingly, the reactor core 104 can include one or more fuel assemblies 101. The fuel assemblies 101 can include fissile and/or other suitable materials. Heat from the reaction generates steam at a steam generator 130, which directs the steam to a power conversion system 140. The power conversion system 140 generates electrical power, and/or provides other useful outputs, such as super-heated steam. A sensor system 150 is used to monitor the operation of the power module 102 and/or other system components. The data obtained from the sensor system 150 can be used in real time to control the power module 102, and/or can be used to update the design of the power module 102 and/or other system components.

The power module 102 includes a containment vessel 110 (e.g., a radiation shield vessel, a pressure vessel, a leakage-prevention vessel, or a radiation shield container) that houses/encloses a reactor vessel 120 (e.g., a reactor pressure vessel, or a reactor pressure container), which in turn houses the reactor core 104. The containment vessel 110 can be housed in a power module bay 156. The power module bay 156 can contain a cooling pool 103 filled with water and/or another suitable cooling liquid. The bulk of the power module 102 can be positioned below a surface 105 of the cooling pool 103. Accordingly, the cooling pool 103 can operate as a thermal sink, for example, in the event of a system malfunction. Additionally, the cooling pool 103 can serve as a radiation shield.

A volume between the reactor vessel 120 and the containment vessel 110 can be partially or completely evacuated to reduce heat transfer from the reactor vessel 120 to the surrounding environment (e.g., to the cooling pool 103). However, in other embodiments the volume between the reactor vessel 120 and the containment vessel 110 can be at least partially filled with a gas and/or a liquid that increases heat transfer between the reactor vessel 120 and the containment vessel 110. For example, the volume between the reactor vessel 120 and the containment vessel 110 can be at least partially filled (e.g., flooded with the primary coolant 107) during an emergency operation. During such an emergency operation, the containment vessel 110 can inhibit or even prevent leakage of the primary coolant 107 into the cooling pool 103 and can serve as a heat exchanger that transfers heat from the primary coolant 107 to the cooling pool 103.

Within the reactor vessel 120, a primary coolant 107 conveys heat from the reactor core 104 to the steam generator 130. For example, as illustrated by arrows located within the reactor vessel 120, the primary coolant 107 is heated at the reactor core 104 toward the bottom of the reactor vessel 120. The heated primary coolant 107 (e.g., water with or without additives) rises from the reactor core 104 through a core shroud 106 and to a riser tube 108. The hot, buoyant primary coolant 107 continues to rise through the riser tube 108, then exits the riser tube 108 and passes downwardly through the steam generator 130. The steam generator 130 includes a multitude of conduits 132 that are arranged circumferentially around the riser tube 108, for example, in a helical pattern, as is shown schematically in FIG. 1. The descending primary coolant 107 transfers heat to a secondary coolant (e.g., water) within the conduits 132, and descends to the bottom of the reactor vessel 120 where the cycle begins again. The cycle can be driven by the changes in the buoyancy of the primary coolant 107, thus reducing or eliminating the need for pumps to move the primary coolant 107.

The steam generator 130 can include a feedwater header 131 at which the incoming secondary coolant enters the steam generator conduits 132. The secondary coolant rises through the conduits 132, converts to vapor (e.g., steam), and is collected at a steam header 133. The steam exits the steam header 133 and is directed to the power conversion system 140.

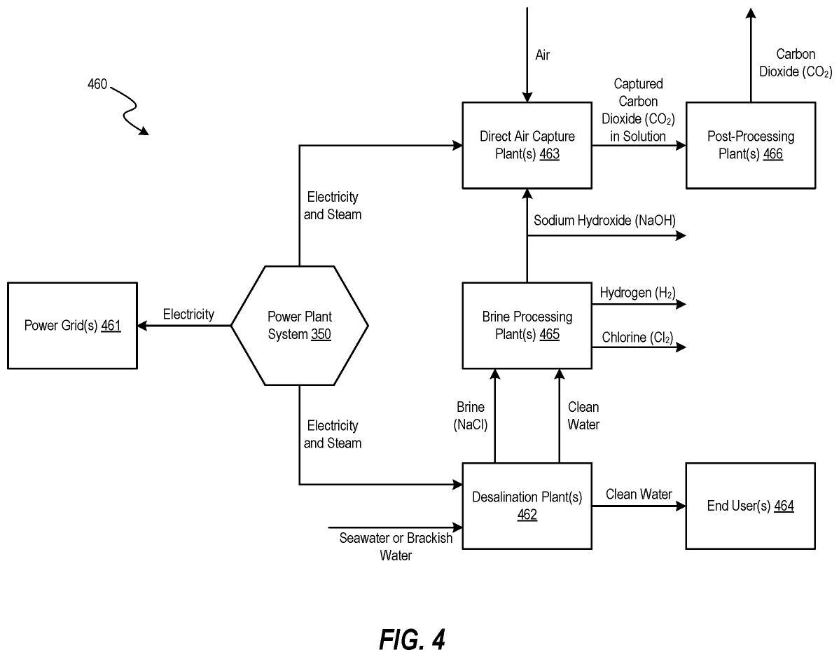

The power conversion system 140 can include one or more steam valves 142 that regulate the passage of high pressure, high temperature steam from the steam generator 130 to a steam turbine 143. The steam turbine 143 converts the thermal energy of the steam to electricity via a generator 144. The low-pressure steam exiting the turbine 143 is condensed at a condenser 145, and then directed (e.g., via a pump 146) to one or more feedwater valves 141. The feedwater valves 141 control the rate at which the feedwater re-enters the steam generator 130 via the feedwater header 131. In other embodiments, the steam from the steam generator 130 can be routed for direct use in an industrial process, such as a desalination plant, a direct air capture plant, a chemical processing plant, and/or the like, as described in detail below with reference to FIGS. 4-12. Accordingly, steam exiting the steam generator 130 can bypass the power conversion system 140.

The power module 102 includes multiple control systems and associated sensors. For example, the power module 102 can include a cylindrical reflector 109 that directs neutrons back into the reactor core 104 to further the nuclear reaction taking place therein. The reflector 109 cam be formed of stainless steel and/or suitable materials and, in some embodiments, includes flow paths (e.g., openings) extending therethrough to permit some of the primary coolant 107 to flow therethrough. Control rods 113 are used to modulate the nuclear reaction, and are driven via fuel rod drivers 115. The pressure within the reactor vessel 120 can be controlled via a pressurizer volume 119 positioned above a pressurizer plate 117 (which can also serve to direct the primary coolant 107 downwardly through the steam generator 130).

The sensor system 150 can include one or more sensors 151 positioned at a variety of locations within the power module 102 and/or elsewhere, for example, to identify operating parameter values and/or changes in parameter values. The data collected by the sensor system 150 can then be used to control the operation of the system 100, and/or to generate configuration changes for the system 100. For sensors positioned within the containment vessel 110, a sensor links 152 directs data from the sensors to a flange 153 (at which the sensor links 152 exits the containment vessel 110) and directs data to a sensor junction box 154. From there, the sensor data can be routed to one or more controllers and/or other data systems via a data bus 155.

FIG. 2 is a partially schematic, partially cross-sectional view of a nuclear reactor system 200 (“system 200”) configured in accordance with additional embodiments of the present technology. In some embodiments, the system 200 can include some features that are at least generally similar in structure and function, or identical in structure and function, to the corresponding features of the system 100 described in detail above with reference to FIG. 1, and can operate in a generally similar or identical manner to the system 100.

In the illustrated embodiment, the system 200 includes a reactor vessel 220 and a containment vessel 210 surrounding/enclosing the reactor vessel 220. In some embodiments, the reactor vessel 220 and the containment vessel 210 can be roughly cylinder-shaped or capsule-shaped. The system 200 further includes a plurality of heat pipe layers 211 within the reactor vessel 220. In the illustrated embodiment, the heat pipe layers 211 are spaced apart from and stacked over one another. In some embodiments, the heat pipe layers 211 can be mounted/secured to a common frame 212, a portion of the reactor vessel 220 (e.g., a wall thereof), and/or other suitable structures within the reactor vessel 220. In other embodiments, the heat pipe layers 211 can be directly stacked on top of one another such that each of the heat pipe layers 211 supports and/or is supported by one or more of the other ones of the heat pipe layers 211.

In the illustrated embodiment, the system 200 further includes a shield or reflector region 214 at least partially surrounding a core region 216. The heat pipes layers 211 can be circular, rectilinear, polygonal, and/or can have other shapes, such that the core region 216 has a corresponding three-dimensional shape (e.g., cylindrical, spherical). In some embodiments, the core region 216 is separated from the reflector region 214 by a core barrier 215, such as a metal wall. The core region 216 can include one or more fuel sources, such as fissile material, for heating the heat pipes layers 211. The reflector region 214 can include one or more materials configured to contain/reflect products generated by consuming the fuel in the core region 216 during operation of the system 200. For example, the reflector region 214 can include a liquid or solid material configured to reflect neutrons and/or other fission products radially inward toward the core region 216. In some embodiments, the reflector region 214 can entirely surround the core region 216. In other embodiments, the reflector region 214 may partially surround the core region 216. In some embodiments, the core region 216 can include a control material 217, such as a moderator and/or coolant. The control material 217 can at least partially surround the heat pipe layers 211 in the core region 216 and can transfer heat therebetween.

In the illustrated embodiment, the system 200 further includes at least one heat exchanger 230 (e.g., a steam generator) positioned around the heat pipe layers 211. The heat pipe layers 211 can extend from the core region 216 and at least partially into the reflector region 214, and are thermally coupled to the heat exchanger 230. In some embodiments, the heat exchanger 230 can be positioned outside of or partially within the reflector region 214. The heat pipe layers 211 provide a heat transfer path from the core region 216 to the heat exchanger 230. For example, the heat pipe layers 211 can each include an array of heat pipes that provide a heat transfer path from the core region 216 to the heat exchanger 230. When the system 200 operates, the fuel in the core region 216 can heat and vaporize a fluid within the heat pipes in the heat pipe layers 211, and the fluid can carry the heat to the heat exchanger 230. The heat pipes in the heat pipe layers 211 can then return the fluid toward the core region 216 via wicking, gravity, and/or other means to be heated and vaporized once again.

In some embodiments, the heat exchanger 230 can be similar to the steam generator 130 of FIG. 1 and, for example, can include one or more helically-coiled tubes that wrap around the heat pipe layers 211. The tubes of the heat exchanger 230 can include or carry a working fluid (e.g., a coolant such as water or another fluid) that carries the heat from the heat pipe layers 211 out of the reactor vessel 220 and the containment vessel 210 for use in generating electricity, steam, and/or the like. For example, in the illustrated embodiment the heat exchanger 230 is operably coupled to a turbine 243, a generator 244, a condenser 245, and a pump 246. As the working fluid within the heat exchanger 230 increases in temperature, the working fluid may begin to boil and vaporize. The vaporized working fluid (e.g., steam) may be used to drive the turbine 243 to convert the thermal potential energy of the working fluid into electrical energy via the generator 244. The condenser 245 can condense the working fluid after it passes through the turbine 243, and the pump 246 can direct the working fluid back to the heat exchanger 230 where it can begin another thermal cycle. In other embodiments, steam from the heat exchanger 230 can be routed for direct use in an industrial process, such as a desalination plant, a direct air capture plant, a chemical processing plant, and/or the like, as described in detail below with reference to FIGS. 4-12. Accordingly, steam exiting the heat exchanger 230 can bypass the turbine 243, the generator 244, the condenser 245, the pump 246, etc.

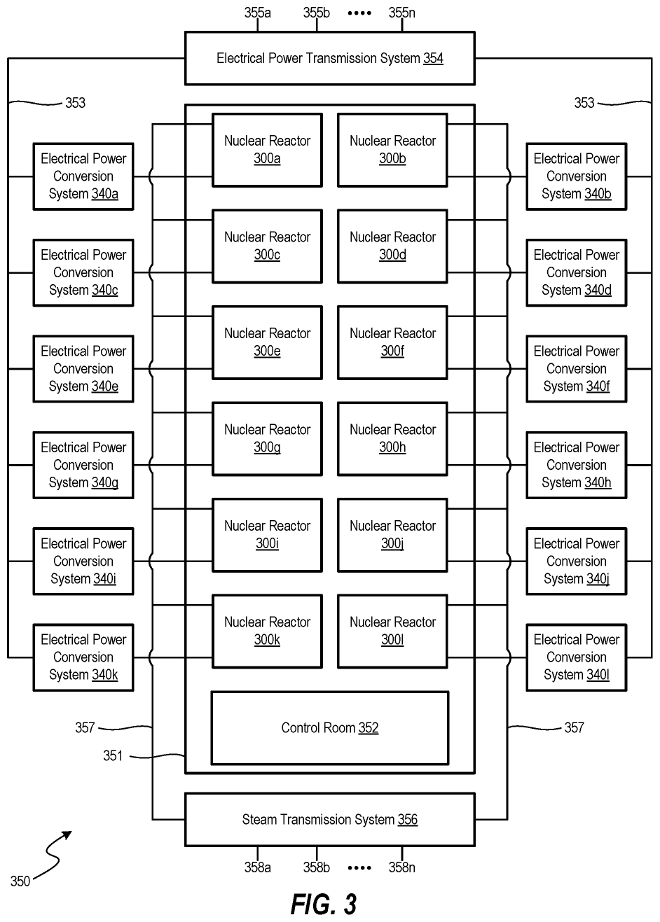

FIG. 3 is a schematic view of a nuclear power plant system 350 (“power plant system 350”) including multiple nuclear reactors 300 (individually identified as first through twelfth nuclear reactors 300a-l, respectively) in accordance with embodiments of the present technology. Each of the nuclear reactors 300 can be similar to or identical to the nuclear reactor 100 and/or the nuclear reactor 200 described in detail above with reference to FIGS. 1 and 2. The power plant system 350 can be “modular” in that each of the nuclear reactors 300 can be operated separately to provide an output, such as electricity or steam. The power plant system 350 can include fewer than twelve of the nuclear reactors 300 (e.g., two, three, four, five, six, seven, eight, nine, ten, or eleven of the nuclear reactors 300), or more than twelve of the nuclear reactors 300. The power plant system 350 can be a permanent installation or can be mobile (e.g., mounted on a truck, tractor, mobile platform, and/or the like). In the illustrated embodiment, each of the nuclear reactors 300 can be positioned within a common housing 351, such as a reactor plant building, and controlled and/or monitored via a control room 352.

Each of the nuclear reactors 300 can be coupled to a corresponding electrical power conversion system 340 (individually identified as first through twelfth electrical power conversion systems 340a-l, respectively). The electrical power conversion systems 340 can include one or more devices that generate electrical power or some other form of usable power from steam generated by the nuclear reactors 300. For example, the electrical power conversion systems 340 can include features that are similar or identical to the power conversion system 140 described in detail above with reference to FIG. 1. In some embodiments, multiple ones of the nuclear reactors 300 can be coupled to the same one of the electrical power conversion systems 340 and/or one or more of the nuclear reactors 300 can be coupled to multiple ones of the electrical power conversion systems 340 such that there is not a one-to-one correspondence between the nuclear reactors 300 and the electrical power conversion systems 340.

The electrical power conversion systems 340 can be further coupled to an electrical power transmission system 354 via, for example, an electrical power bus 353. The electrical power transmission system 354 and/or the electrical power bus 353 can include one or more transmission lines, transformers, and/or the like for regulating the current, voltage, and/or other characteristic(s) of the electricity generated by the electrical power conversion systems 340. The electrical power transmission system 354 can route electricity via a plurality of electrical output paths 355 (individually identified as electrical output paths 355a-n) to one or more end users and/or end uses, such as different electrical loads of an integrated energy system as described in greater detail below with reference to FIGS. 4-12.

Each of the nuclear reactors 300 can further be coupled to a steam transmission system 356 via, for example, a steam bus 357. The steam bus 357 can route steam generated from the nuclear reactors 300 to the steam transmission system 356 which in turn can route the steam via a plurality of steam output paths 358 (individually identified as steam output paths 358a-n) to one or more end users and/or end uses, such as different steam inputs of an integrated energy system as described in greater detail below with reference to FIGS. 4-12.

In some embodiments, the nuclear reactors 300 can be individually controlled (e.g., via the control room 352) to provide steam to the steam transmission system 356 and/or steam to the corresponding one of the electrical power conversion systems 340 to provide electricity to the electrical power transmission system 354. In some embodiments, the nuclear reactors 300 are configured to provide steam either to the steam bus 357 or to the corresponding one of the electrical power conversion systems 340, and can be rapidly and efficiently switched between providing steam to either. Accordingly, in some aspects of the present technology the nuclear reactors 300 can be modularly and flexibly controlled such that the power plant system 350 can provide differing levels/amounts of electricity via the electrical power transmission system 354 and/or steam via the steam transmission system 356. For example, where the power plant system 350 is used to provide electricity and steam to one or more industrial process—such as various components of the integrated energy systems described in the detail below with reference to FIGS. 4-12—the nuclear reactors 300 can be controlled to meet the differing electricity and steam requirements of the industrial processes.

As one example, during a first operational state of an integrated energy system employing the power plant system 350, a first subset of the nuclear reactors 300 (e.g., the first through sixth nuclear reactors 300a-f) can be configured to provide steam to the steam transmission system 356 for use in the first operational state of the integrated energy system, while a second subset of the nuclear reactors 300 (e.g., the seventh through twelfth nuclear reactors 300g-l) can be configured to provide steam to the corresponding ones of the electrical power conversion systems 340 (e.g., the seventh through twelfth electrical power conversion systems 340g-l) to generate electricity for the first operational state of the integrated energy system. Then, during a second operational state of the integrated energy system when a different (e.g., greater or lesser) amount of steam and/or electricity is required, some or all the first subset of the nuclear reactors 300 can be switched to provide steam to the corresponding ones of the electrical power conversion systems 340 (e.g., the seventh through twelfth electrical power conversion systems 340g-l) and/or some or all of the second subset of the nuclear reactors 300 can be switched to provide steam to the steam transmission system 356 to vary the amount of steam and electricity produced to match the requirements/demands of the second operational state. Other variations of steam and electricity generation are possible based on the needs of the integrated energy system. That is, the nuclear reactors 300 can be dynamically/flexibly controlled during other operational states of an integrated energy system to meet the steam and electricity requirements of the operational state.

In contrast, some conventional nuclear power plant systems can typically generate either steam or electricity for output, and cannot be modularly controlled to provide varying levels of steam and electricity for output. Moreover, it is typically difficult (e.g., expensive, time consuming, etc.) to switch between steam generation and electricity generation in conventional nuclear power plant systems. Specifically, for example, it is typically extremely time consuming to switch between steam generation and electricity generation in prototypical large nuclear power plant systems.

The nuclear reactors 300 can be individually controlled via one or more operators and/or via a computer system. Accordingly, many embodiments of the technology described herein may take the form of computer- or machine- or controller-executable instructions, including routines executed by a programmable computer or controller. Those skilled in the relevant art will appreciate that the technology can be practiced on computer/controller systems other than those shown and described herein. The technology can be embodied in a special-purpose computer, controller or data processor that is specifically programmed, configured or constructed to perform one or more of the computer-executable instructions described below. Accordingly, the terms “computer” and “controller” as generally used herein refer to any data processor and can include Internet appliances and hand-held devices (including palm-top computers, wearable computers, cellular or mobile phones, multi-processor systems, processor-based or programmable consumer electronics, network computers, mini computers and the like). Information handled by these computers can be presented at any suitable display medium, including a liquid crystal display (LCD).

The technology can also be practiced in distributed environments, where tasks or modules are performed by remote processing devices that are linked through a communications network. In a distributed computing environment, program modules or subroutines may be located in local and remote memory storage devices. Aspects of the technology described herein may be stored or distributed on computer-readable media, including magnetic or optically readable or removable computer disks, as well as distributed electronically over networks. Data structures and transmissions of data particular to aspects of the technology are also encompassed within the scope of the embodiments of the technology.

### II. Select Embodiments of Integrated Energy Systems

The power plant system 350 of FIG. 3 can be coupled to one or more industrial processes and/or systems to form an integrated energy system for producing green sodium hydroxide (NaOH) for use in direct air capture processes to capture atmospheric carbon dioxide. For example, FIG. 4 is a schematic diagram of an integrated energy system 460 including the power plant system 350 of FIG. 3 in accordance with embodiments of the present technology. The integrated energy system 460 can be an Integrated Energy System (IES) of the type described and/or recognized by the U.S. Department of Energy (DOE).

In the illustrated embodiment, the integrated energy system 460 is generally configured to treat seawater and/or brackish water to produce brine and clean water, treat the brine to generate sodium hydroxide (NaOH), and utilize the sodium hydroxide in a direct air capture process to capture carbon dioxide (CO₂) from atmospheric air. Specially, the power plant system 350 is configured to generate electricity and route the electricity (e.g., via one or more power lines, via the electrical power transmission system 354 of FIG. 3) to one or more power grids 461, one or more desalination plants 462, and one or more direct air capture plants 463. The power plant system 350 is further configured to generate steam and route the steam (e.g., via one or more steam transmission lines, via the steam transmission system 356 of FIG. 3) to the desalination plant 462 and the direct air capture plant 463.

The power grid 461 can supply power to a plurality of remote end users, or can be dedicated to a specific consumer. The power plant system 350 can be a permanent or temporary installation built at or near the location of the desalination plant 462 and/or the direct air capture plant 463, or can be a mobile or partially mobile system that is moved to and assembled at or near the location of the desalination plant 462 and/or the direct air capture plant 463. More generally, the power plant system 350 can be local (e.g., positioned at or near) the industrial processes/operations it supports, such as the desalination plant 462 and the direct air capture plant 463. For example, the power plant system 350 can be located within 0.4 km (0.25 mile), within 0.8 km (0.5 mile), within 3.22 km (2 miles), within 4.82 km (3 miles), or within 8.1 km (5 miles) of the industrial processes/operations it supports. In some embodiments, the power plant system 350 includes four, six, twelve, or a different number of the nuclear reactors 300 (FIG. 3) and has a power output of between 308-924 megawatts electrical (MWe). In some embodiments, the power plant system 350 can output between about 308-462 MWe. In some embodiments, the power plant system 350 is a floating nuclear power plant and/or can be positioned at a coastal location near the desalination plant 462.

The desalination plant 462 can receive and process seawater, brackish water, and/or other saline water to produce clean water (e.g., drinking water) and sodium chloride (NaCl), which is commonly referred to as brine, as a byproduct. Accordingly, in some embodiments the desalination plant 462 can be positioned near a source of seawater or brackish water, such along the coastline of an arid country that lacks useful clean water for metropolitans and industries. The desalination plant 462 can treat the seawater or brackish water to produce clean water and brine using a desalination process (e.g., vacuum distillation, multi-stage flash distillation, multiple-effect distillation (MED), vapor-compression distillation, and/or the like), an osmosis process (e.g., reverse osmosis (RO), forward osmosis), an electrodialysis process, and/or the like. For example, the desalination plant 462 can utilize a reverse osmosis process that uses semipermeable membranes and applied pressure (e.g., on the membrane feed side) to preferentially induce water permeation through the membrane while rejecting salts.

In the illustrated embodiment, some of the clean water is routed to one or more end users 464, such as homes, hospitals, industries, cities, etc. Brine is a high-concentration water solution of sodium chloride ranging from about 4% up to about 26%. Brine is denser than seawater or brackish water, and therefore will sink to the bottom of the ocean if released therein, which can damage the oceanic ecosystem. Studies have shown that dilution is not a solution because brine dispersal from desalination plants can travel several kilometers away, meaning that it has the potential to cause harm to ecosystems far away from the desalination plants. Brine in small quantities can be used for food processing and for de-icing of roads. But, due to the large volume that is generated from, for example, RO desalination processes, an innovative process to reprocess the brine is desired to ensure that a desalination process to produce clean water for consumption and for industrial usage can be encouraged and deployed. Typically, a RO process generates clean water to brine at ratio of about 1 to 1.4, that is, 1 volume of clean water to 1.4 volume of brine solution.

In the illustrated embodiment, the integrated energy system 460 further comprises one or more brine processing plants 465 operably coupled to the desalination plant 462. The brine processing plant 465 is configured to receive brine and clean water from the desalination plant 462 and to process the brine to generate chlorine (Cl₂), hydrogen (H₂), and sodium hydroxide (NaOH). In some embodiments, the brine processing plant 465 is configured to treat the brine using an electrolysis process, such as the Chlor-Alkali Membrane process, to produce sodium hydroxide from a solution of sodium chloride. The Chlor-Alkali Membrane process can employ a membrane cell, and can be referred to as a membrane cell process. The membrane cell process can use a membrane cell to partition the brine solution so that Cl⁻ ions are inhibited or even prevented from migrating to the cathode side of the cell to react with the produced sodium hydroxide solution. The process can also simultaneously produce chlorine gas and hydrogen gas. The sodium hydroxide builds up at the cathode, where water is reduced to hydrogen gas and hydroxide ions (OH) according to equation (1) below:

2Na⁺+2H₂O+2e^{-→H}₂2NaOH (1)

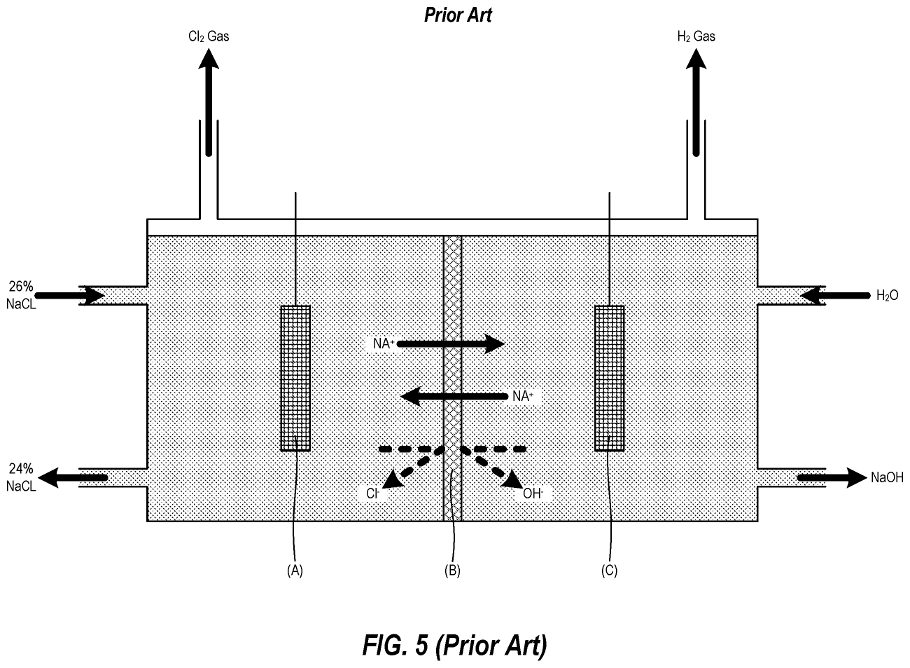

As a result, the sodium hydroxide typically can be collected at the cathode. More specifically, FIG. 5 is a schematic diagram of a membrane cell for carrying out the Chlor-Alkali Membrane process via the electrolysis of aqueous sodium chloride (e.g., brine) in accordance with the prior art. The brine can be provided from the desalination plant 462 (FIG. 4). As shown, at an anode (A), chloride (Cl⁻) is oxidized to chlorine and chlorine gas is formed. An ion-selective membrane (B) allows the counter ion Na⁺ to freely flow across, but inhibits or even prevents anions such as hydroxide (OH⁻) and chloride from diffusing across into the opposite sides. The membrane (B) can be an asbestos, mercury, or fluorine-containing ion-exchange membrane. At a cathode (C), water (H₂O) is reduced to hydroxide and hydrogen gas. The water can be provided from the desalination plant 462 (FIG. 4).

The chemical reactions that take place are as follows. First, saturated brine is passed into a first chamber of the membrane cell where the chloride ions are oxidized at the anode (A), losing electrons to become chlorine gas according to equation (2) below:

2Cl→Cl₂+2e (2)

Sodium ions (Na⁺) pass to the second chamber where they react with the hydroxide ions to produce caustic soda (NaOH). Positive hydrogen ions pulled from water molecules are reduced by the electrons provided by the electrolytic current, to hydrogen gas, releasing hydroxide ions into the solution according to equation (3) below:

2H₂O+2e→H₂+2OH (3)

Accordingly, the prescribed overall reaction for the electrolysis of brine is given by equation (4) below:

2NaCl+2H₂O→Cl₂+H₂+2NaOH (4)

In some embodiments, the brine processing plant 465 is configured to remove impurities from the brine received from the desalination plant 462 prior to processing the brine to produce sodium hydroxide. For example, the brine can undergo precipitation and filtration to remove impurities.

Referring again to FIG. 4, the direct air capture plant 463 can receive electricity and steam from the power plant system 350, air from the atmosphere, and sodium hydroxide from the brine processing plant 465 and utilize the sodium hydroxide, electricity, and/or steam in a direct air capture (DAC) process to generate (e.g., sequester, separate, capture) carbon dioxide (CO₂) in solution from the air. The integrated energy system 460 can further include one or more post-processing plant(s) 466 positioned to receive the captured carbon dioxide in solution from the direct air capture plant 463 and to generate (e.g., release) carbon dioxide (e.g., in liquid, solid, and/or gaseous form) from the captured carbon dioxide in solution and/or to produce other useful chemicals. The carbon dioxide generated by the post-processing plant 466 can be utilized to produce chemicals, bricks, plastic, bottles, etc., and/or can be stored (e.g., geologically). In some embodiments, the post-processing plant 466 utilizes steam and/or electricity from the power plant system 350. The direct air capture plant 463 can carry out several different DAC processes and can, accordingly, have different configurations. For example, the direct air capture plant 463 can carry out a liquid direct air capture process in which air containing carbon dioxide is passed through a liquid sorbent chemical solution to remove the carbon dioxide, or a solid direct air capture process in which air containing carbon dioxide is passed through a solid sorbent chemical filter to remove the carbon dioxide. Both the liquid and solid direct air capture processes rely on two steps—first, the air is captured using an air contactor and second the liquid solvent (e.g., aqueous alkaline solutions) or solid sorbent (e.g., solid alkali carbonates, amine functionalized materials, metal organic frameworks (MOFs), zeolites, and/or the like) is regenerated while the captured carbon dioxide is generated for subsequent sequestration or for reuse to produce useful chemicals and/or materials. Specifically, in some embodiments the direct air capture plant 463 uses the sodium hydroxide from the brine processing plant 465 as a liquid sorbent for direct air capture. Accordingly, the captured carbon dioxide in solution can comprise carbon dioxide in solution with sodium hydroxide. In some embodiments, the direct air capture plant 463 and the post-processing plant 466 can be integrated into a single plant. Accordingly, the direct air capture plant 463 and the post-processing plant 466 can together be referred to as a “direct air capture plant,” a “direct air capture and post-processing plant,” and/or the like.

FIG. 6 is a schematic diagram of a direct air capture plant 663 and a post-processing plant 666 in accordance with the prior art. In the illustrated embodiment, the direct air capture plant 663 is configured to remove carbon dioxide from the air by reacting the carbon dioxide with the strong alkali solution of sodium hydroxide. Such a process can be referred to as a “scrubbing,” “chemical scrubbing,” “chemical absorption,” and/or similar process. In general, the chemical absorption process carried out by the direct capture plant 663 illustrated in FIG. 6 uses a reactive solution of sodium hydroxide to selectively absorb the carbon dioxide from a feed gas (e.g., the atmospheric air). After absorption, the CO₂-rich solution is processed by the post-processing plant 666 reversing the reaction such that a concentrated stream of carbon dioxide gas is produced, with the solvent regenerated for reuse. This “stripping” of carbon dioxide from the solvent requires the input of heat, which generally dominates the energy requirement of the capture process.

As shown, the direct capture plant 663 comprises a carbon dioxide absorber 671, and the post-processing plant 666 comprises a causticizing reactor 672, a filter 673, a lime hydration reactor 674, a steam dryer 675, a furnace 676, and a compressor 677. The direct capture plant 663 receives the sodium hydroxide and directs the sodium hydroxide to the carbon dioxide absorber 671. The sodium hydroxide can be in aqueous form. The carbon dioxide absorber 671 can receive air (e.g., atmospheric air) and process the air and sodium hydroxide to produce aqueous sodium carbonate (Na₂CO₃), and route the sodium carbonate to the causticizing reactor 672. The causticizing reactor 672 can further receive water (H₂O) from the filter 673 (e.g., a mechanical filter) and solid calcium hydroxide (Ca(OH)₂) from the lime hydration reactor 674 and process the water, sodium carbonate, and the calcium hydroxide to produce water and solid calcium carbonate (CaCO₃) for output to the filter 673. Some or all of the water can be routed/recirculated between the causticizing reactor 672 and the filter 675. The filter 673 can output filtered, wet calcium carbonate and route some or all of the wet calcium carbonate to the steam dryer 675. The steam dryer 675 can receive heated steam and water in liquid or gaseous form from the lime hydration reactor 674 and/or another source to produce calcium carbonate in solid (e.g., dry) form. The furnace 676 (e.g., a kiln) can receive the solid calcium carbonate and heat the calcium carbonate to produce (e.g., generate, release) carbon dioxide and solid calcium oxide (CaO). The calcium oxide can be routed/recirculated back to the lime hydration reactor 674 for use in producing the calcium hydroxide for routing to the causticizing reactor 672 and/or water for routing to the steam dryer 675. In the illustrated embodiment, the produced calcium oxide is used to regenerate the liquid sorbent sodium hydroxide for further use in the carbon dioxide absorber 671. Finally, the carbon dioxide produced by the furnace 676 can be routed to the compressor 677, which is configured to compress the carbon dioxide into a liquid, solid, and/or gaseous form for storage, sequestration, and/or use in one or more industrial processes (e.g., plastic production).

The direct air capture process carried out by the direct air capture plant 663 illustrated in FIG. 6 can use a relatively large quantity of electrical and/or thermal energy per unit of carbon dioxide captured. For example, the capture of one megaton of carbon dioxide can require between about 1.4-2.5 megawatt hours of energy.

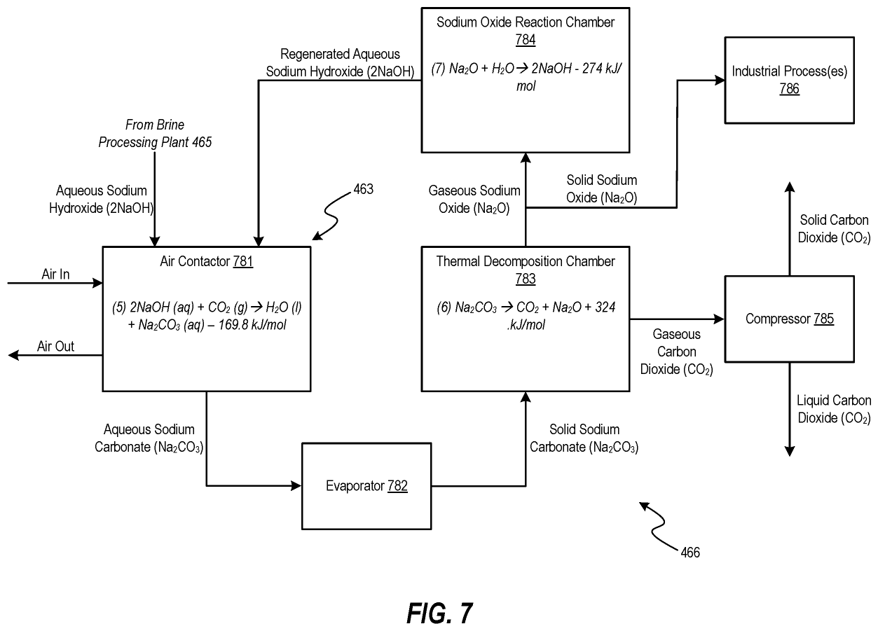

FIG. 7 is a schematic diagram of the direct air capture plant 463 and the post-processing plant 466 of FIG. 4 in accordance with embodiments of the present technology. In the illustrated embodiment, the direct air capture plant 463 is configured to eliminate the use of calcium oxide to regenerate the liquid sorbent sodium hydroxide (e.g., as compared to the prior art process shown in FIG. 6) by introducing an evaporation step and a thermal decomposition step to release the captured carbon dioxide and regenerate an intermediate compound, sodium oxide (Na₂O), which can be used to regenerate the liquid sorbent via hydrolysis. More specifically, in the illustrated embodiment the direct capture plant 463 comprises an air contactor 781, and the post-processing plant 466 comprises an evaporator 782, a thermal decomposition chamber 783, a sodium oxide reaction chamber 784, and a compressor 785. Each of these components 781-785 can operate using electricity and/or steam produced by the power plant system 350 (FIG. 4) and selectively routed to the direct air capture plant 463, and/or via electrical and/or steam inputs from other energy sources.

The direct capture plant 463 can receive at least a portion of the sodium hydroxide from the brine processing plant 465 (FIG. 4) and direct the sodium hydroxide to the air contactor 781. The sodium hydroxide can be in aqueous form. The air contactor 781 can receive the air (e.g., atmospheric air) and process the air and sodium hydroxide to produce aqueous sodium carbonate (Na₂CO₃) according to equation (5) below, and route the sodium carbonate to the evaporator 782 (e.g., an evaporation chamber). The reaction is endothermic, requiring about −169.8 kilojoules per mole, and the sodium carbonate is soluble and remains in solution with the sodium hydroxide. More specifically, the air contactor 781 can suck in ambient air with a blower and/or fan and blow the air across a carbon dioxide solution curtain containing the sodium hydroxide. The air contactor 781 can release the air with a lower carbon dioxide content.

2NaOH+CO₂→H₂O+Na₂CO₃ (5)

The evaporator 782 can heat the sodium carbonate to evaporate water, sodium hydroxide, and/or other liquids therefrom and route the sodium carbonate in solid form to the thermal decomposition chamber 783. In some embodiments, for evaporation to take place, the evaporator 782 can utilize approximately 330-400 (e.g., about 366) kilowatt hours of energy and a vertical moisture gradient to evaporate water from the aqueous sodium carbonate. Approximately 0.7 kWh of heat must be added to a gram of water for it to evaporate into the air. This energy is called “the latent heat of vaporization.” This energy is locked up in the water molecules (vapor). This energy remains latent in the water molecules until they are combined during condensation process to form a liquid (water). When this happens, the latent energy is released back into its surrounding as heat. In some embodiments, the evaporator 782 or another component of the direct air capture plant 463 can salvage this released heat as recoverable energy.

The thermal decomposition chamber 783 is configured to heat the sodium carbonate to above 500 degrees Celsius or hotter to decompose the solid sodium carbonate into gaseous carbon dioxide and gaseous sodium oxide (Na₂O) according to equation (6) below. The reaction is exothermic, releasing about 324 kilojoules per mole. In some embodiments, decomposition begins at 500 degrees Celsius and complete decomposition occurs at greater than 900 degrees Celsius. In some embodiments, the direct air capture plant 463 can salvage the energy (e.g., heat) released by the decomposition of sodium carbonate as recoverable energy.

Na₂CO₃→CO₂+Na₂O (6)

The resultant carbon dioxide can be routed to the compressor 785, which is configured to compress the carbon dioxide into a liquid, solid, and/or gaseous form for storage and/or use in one or more industrial processes. The resultant sodium oxide can be routed to the sodium oxide reaction chamber 784, which is configured to react the sodium oxide with water to regenerate sodium hydroxide, according to equation (7) below, for use in the air contactor 781 as a liquid sorbent. The reaction is endothermic, requiring about −274 kilojoules per mole. Alternatively, or additionally, some of the sodium oxide can be routed for use in one or more industrial processes 786, such for high-quality optic and glass generation, especially for solar panel applications.

Na₂O+H₂O→2NaOH (7)

In some aspects of the present technology, the direct air capture plant 463 illustrated in FIG. 7 can use a large volume of NaOH (e.g., supplied from the brine processing plant 465 of FIG. 4) such that a large number of contactors can be used in the air contactor 781 to increase the reaction cross-sectional area and therefore the amount of carbon dioxide captured from the air. Some conventional direct air capture processes are limited by the amount of available sodium hydroxide. In additional aspects of the present technology, the direct air capture plant 463 illustrated in FIG. 7 can require significantly less energy to operate than conventional direct air capture processes (e.g., the prior art process illustrated in FIG. 6) as (i) energy can be recovered from the evaporator 782 and the thermal decomposition chamber 783 and (ii) the process does not require a secondary loop that uses calcium oxide to recover and to regenerate sodium hydroxide, instead using sodium oxide to recover and to regenerate sodium hydroxide. That is, the DAC process illustrated in FIG. 7 does not require the utilization of any calcium oxide.

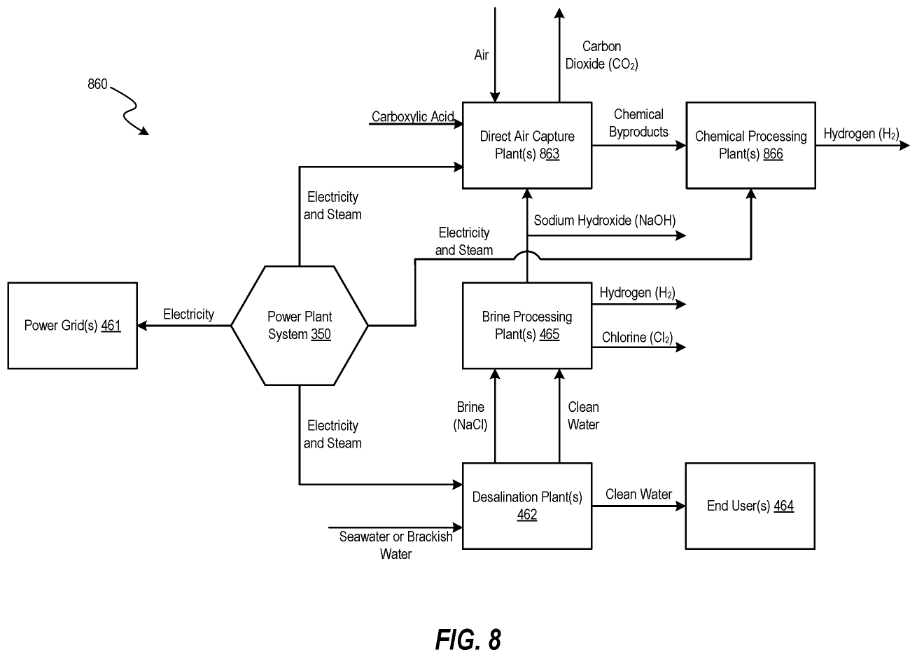

In some embodiments, an integrated energy system in accordance with the present technology can be configured to treat a capturing solution of sodium carbonate with a carboxylic acid, such as formic acid or acetic acid, to regenerate carbon dioxide and other useful chemical byproducts such as sodium formate or sodium acetate. In such embodiments, the liquid sorbent sodium hydroxide is not regenerated, and the chemical byproducts can be processed to, for example, generate hydrogen as an energy carrier. More specifically, FIG. 8 is a schematic diagram of an integrated energy system 860 including the power plant system 350 of FIG. 3 in accordance with additional embodiments of the present technology. The integrated energy system 860 can include some features that are at least generally similar in structure and function, or identical in structure and function, to the corresponding features of the integrated energy system 460 described in detail above with reference to FIG. 4, and can operate in a generally similar or identical manner to the integrated energy system 460. For example, in the illustrated embodiment the integrated energy system 860 includes the power grid 461, the desalination plant 462, and the brine processing plant 465. The integrated energy system 860 can be an Integrated Energy System (IES) of the type described and/or recognized by the U.S. Department of Energy (DOE).

In the illustrated embodiment, the integrated energy system 860 includes one or more direct air capture plants 863 (i) positioned to receive electricity and steam from the power plant system 350, carboxylic acid (e.g., an organic acid) from a source of carboxylic acid, air from the atmosphere, and sodium hydroxide from the brine processing plant 465 and (ii) configured to utilize the sodium hydroxide, carboxylic acid, electricity, and/or steam in a direct air capture process to generate (e.g., sequester, separate, capture) carbon dioxide (CO₂) from the air. The direct air capture process can further generate useful chemical byproducts such as sodium formate or sodium acetate. Accordingly, in some embodiments the integrated energy system 860 includes one or more chemical processing plants 866, such as a hydrogen generation plant, sodium formate processing plant, sodium acetate processing plant, and/or the like positioned to receive the chemical byproducts from the direct air capture plant 863 and electricity and/or steam from the power plant system 350. The chemical processing plant 866 can process the chemical byproducts from the direct air capture plant 863 to produce hydrogen and other useful chemical products such as sodium carbonate, sodium formate, sodium oxalate, and/or other chemicals.

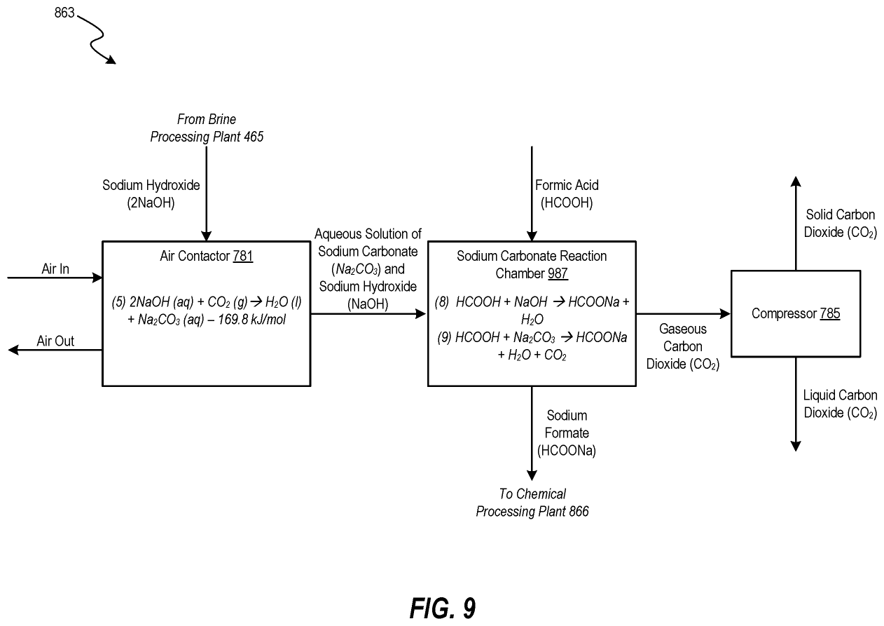

In some embodiments the carboxylic acid can comprise formic acid. Formic acid is part of the organic acid group. FIG. 9 is a schematic diagram of the direct air capture plant 863 of FIG. 8 configured to utilize formic acid in a direct air capture process in accordance with embodiments of the present technology. The direct air capture plant 863 can include some features that are at least generally similar in structure and function, or identical in structure and function, to the corresponding features of the direct air capture plant 463 and/or the post-processing plant 466 described in detail above with reference to FIGS. 4 and 7. For example, in the illustrated embodiment the direct air capture plant 863 includes the air contactor 781 and the compressor 785 described in detail above with reference to FIG. 7.

In the illustrated embodiment, the direct air capture plant 863 further includes a sodium carbonate reaction chamber 987 operably positioned between the air contactor 781 and the compressor 785. Each of the air contactor 781, the sodium carbonate reaction chamber 987, and the compressor 785 can operate using electricity and/or steam produced by the power plant system 350 (FIG. 8) and selectively routed to the direct air capture plant 863, and/or via electrical and/or steam inputs from other energy sources.

As described in detail above, the air contactor 781 can receive sodium hydroxide (2NaOH) from the brine processing plant 465 and use the sodium hydroxide as a liquid sorbent to capture carbon dioxide from atmospheric air—outputting a solution of aqueous sodium carbonate (Na₂CO₃) and sodium hydroxide according to equation (5) above. In the illustrated embodiment, the sodium carbonate reaction chamber 987 is positioned to receive formic acid (HCOOH) and the aqueous solution of sodium carbonate and sodium hydroxide, and is configured to react the formic acid with the solution to produce (e.g., release, generate, regenerate) gaseous carbon dioxide (CO₂) and sodium formate (HCOONa) according to equations (8) and (9) below:

HCOOH+NaOH→HCOONa+H₂O (8)

HCOOH+Na₂CO₃→HCOONa+H₂O+CO₂ )9)

The carbon dioxide in the capturing solution produced in the air contactor 781 is released (e.g., re-generated) in gaseous from and can be routed to the compressor 785, which is configured to compress the carbon dioxide into a liquid, solid, and/or gaseous form for storage (e.g., sequestration) and/or use in one or more industrial processes. The resultant sodium formate can be routed to the chemical processing plant 866 for use in, for example, producing hydrogen as an energy carrier. In some aspects of the present technology, the carbon dioxide can be released from the capturing solution without the use of copious energy typically required by conventional direct air capture processes.

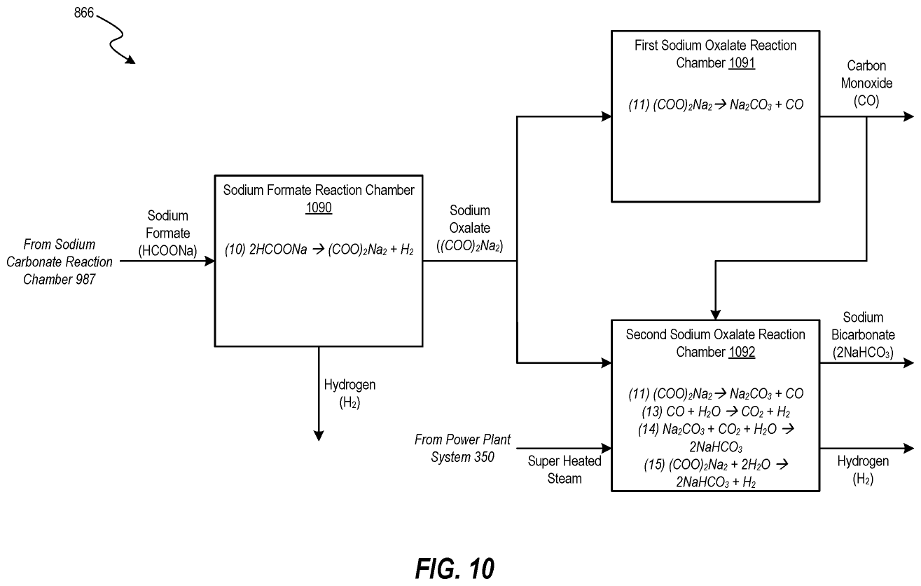

FIG. 10 is a schematic diagram of the chemical processing plant 866 of FIG. 8 configured to utilize sodium formate produced by the direct air capture plant 863 of FIG. 9 to produce hydrogen in accordance with embodiments of the present technology. In the illustrated embodiment, the chemical processing plant 866 (e.g., sodium formate processing plant, hydrogen generation plant) includes a sodium formate reaction chamber 1090, a first sodium oxalate reaction chamber 1091, and a second sodium oxalate reaction chamber 1092. Each of these components 1090-1092 can operate using electricity and/or steam produced by the power plant system 350 (FIG. 8) and selectively routed to the chemical processing plant 866, and/or via electrical and/or steam inputs from other energy sources.

The sodium formate reaction chamber 1090 is positioned to receive the sodium formate (HCOONa) produced by the sodium carbonate reaction chamber 987 (FIG. 9) and configured to heat the sodium formate (e.g., via electricity and/or steam supplied by the power plant system 350 of FIG. 8). Upon heating, the sodium formate decomposes to form sodium oxalate ((COO)₂Na₂) and hydrogen gas (H₂) according to equation (10) below:

2HCOONa→(COO)₂Na₂+H₂ (10)

Hydrogen is released when the temperature is kept below 450 degrees Celsius. When the temperature is increased to above 450 degrees Celsius, sodium carbonate (Na₂CO₃) will form and carbon monoxide (CO) is released according to equation (11) below:

(COO)₂Na₂→Na₂CO₃+CO (11)

Therefore, in some aspects of the present technology the sodium formate reaction chamber 1090 can be maintain the temperature below 300 degrees Celsius to minimize the production of carbon monoxide.

In some embodiments, the first sodium oxalate reaction chamber 1091 is positioned to receive at least a portion of the sodium oxalate produced by the sodium formate reaction chamber 1090 and configured to heat the sodium oxalate (e.g., via electricity and/or steam supplied by the power plant system 350 of FIG. 8) to a temperature greater than 400 degrees Celsius to generate carbon monoxide and sodium carbonate according to equation (11) above. The carbon monoxide can be used as a feedstock for re-generating sodium formate. For example, a sodium formate production plant (not shown) can receive (i) the carbon monoxide, (ii) electricity and steam from the power plant system 350 (FIG. 8), and (iii) sodium hydroxide from the brine processing plant 465 (FIG. 8) and to utilize these components to produce sodium formate (HCOONa). In some embodiments, the sodium formate production plant can utilize the electricity and/or steam from the power plant system to heat the carbon monoxide and the sodium formate to about 130 degrees Celsius and to pressurize the carbon monoxide and sodium formate to between about 6-8 bar (e.g., within a reaction chamber) such that the carbon monoxide is absorbed into the sodium hydroxide to produce solid sodium formate. The reaction is given by equation (12) below. Such production of sodium formate can include features/processes generally similar or identical to those described in, for example, U.S. patent application Ser. No. 18/486,971, titled “SMALL MODULAR NUCLEAR REACTOR INTEGRATED ENERGY SYSTEMS FOR IN-SITU, ON-DEMAND HYDROGEN GENERATION AND/OR THE PRODUCTION OF SODIUM FORMATE,” and filed Oct. 13, 2023, which is incorporated by reference herein in its entirety.

CO+NaOH→HCOONₐ (12)

In some embodiments, the second sodium oxalate reaction chamber 1092 is positioned to receive at least a portion of the sodium oxalate produced by the sodium formate reaction chamber 1090, super-heated steam from the power plant system 350 of FIG. 8, and at least a portion of the carbon monoxide generated by the first sodium oxalate reaction chamber 1091. In some embodiments, the steam has a temperature greater than 750 degrees Celsius. Steam from the power plant system 350 can be routed through an auxiliary heater to reach the desired temperature. The second sodium oxalate reaction chamber 1092 can utilize the super-heated steam in a catalytic steam reforming process to (i) generate sodium carbonate (Na₂CO₃) and carbon monoxide (CO) according to equation (11) above and (ii) react the super-heated steam (H₂O) with the carbon monoxide such that additional hydrogen (H₂) is released and carbon dioxide (CO₂) is formed according to equation (13) below:

CO+H₂O→CO₂+H₂ (13)

The second sodium oxalate reaction chamber 1092 can further allow the carbon dioxide from the catalytic steam reforming process to react with the sodium carbonate and additional steam from the power plant system 350 to produce sodium bicarbonate (NaHCO₃; baking soda) according to equation (14) below combining equations (11) and (13) above:

Na₂CO₃+CO₂+H₂O→2NaHCO₃ (14)

Accordingly, the overall prescribed reaction by combining equations (11), (13), and (14) is given by equation (15) below:

(COO)₂Na₂+2H₂O→2NaHCO₃+H₂ (15)

Accordingly, the chemical processing plant 866 can utilize the electricity and steam from the power plant system 350 to process the sodium formate to produce hydrogen and other chemical byproducts such as sodium carbonate (according to equation (11) above) and/or sodium bicarbonate (according to equation (15) above). In some aspects of the present technology, the carbon dioxide produced in equation (13) is not released and becomes part of the finally produced sodium bicarbonate in equation (14)—reducing or eliminating entirely carbon dioxide emissions. The sodium carbonate, sodium bicarbonate, and/or other chemical byproducts (e.g., sodium oxalate) can be utilized for other industrial processes. The produced hydrogen can be used in industrial processes or to, for example, generate electricity to support an energy imbalance market (EIM) as described in U.S. patent application Ser. No. 18/486,971, titled “SMALL MODULAR NUCLEAR REACTOR INTEGRATED ENERGY SYSTEMS FOR IN-SITU, ON-DEMAND HYDROGEN GENERATION AND/OR THE PRODUCTION OF SODIUM FORMATE,” and filed Oct. 13, 2023, which is incorporated by reference herein in its entirety.

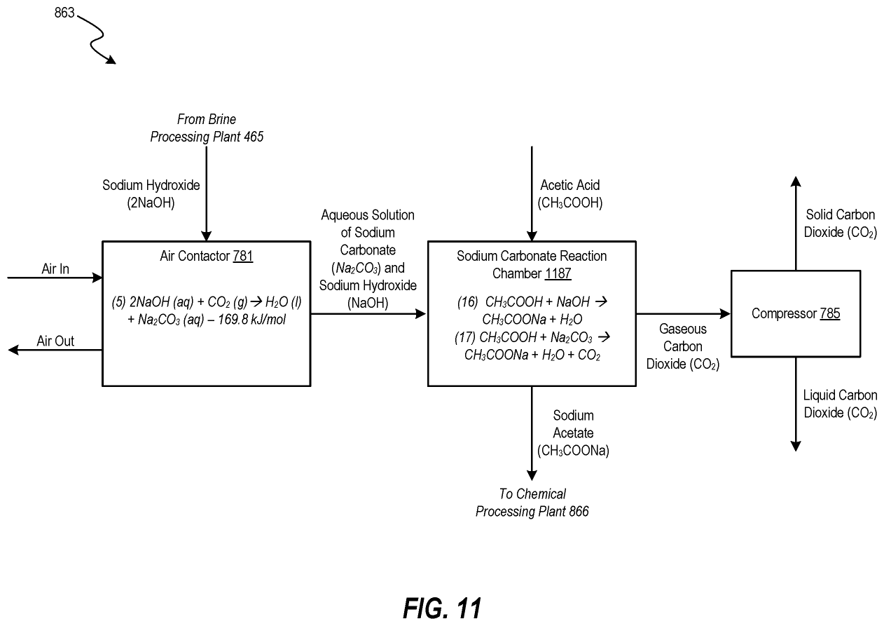

Referring again to FIG. 8, in some embodiments the organic acid supplied to the direct air capture plant 863 can comprise acetic acid (e.g., vinegar). Acetic acid is a carboxylic acid and is part of the organic acid group. FIG. 11 is a schematic diagram of the direct air capture plant 863 of FIG. 8 configured to utilize acetic acid in a direct air capture process in accordance with embodiments of the present technology. The direct air capture plant 863 can include some features that are at least generally similar in structure and function, or identical in structure and function, to the corresponding features of the direct air capture plant 463 and/or the post-processing plant 466 described in detail above with reference to FIGS. 4 and 7 and/or the direct air capture plant 863 described in detail above with reference to FIG. 9. For example, in the illustrated embodiment the direct air capture plant 863 includes the air contactor 781 and the compressor 785 described in detail above with reference to FIGS. 7 and 9.

In the illustrated embodiment, the direct air capture plant 863 further includes a sodium carbonate reaction chamber 1187 operably positioned between the air contactor 781 and the compressor 785. Each of the air contactor 781, the sodium carbonate reaction chamber 1187, and the compressor 785 can operate using electricity and/or steam produced by the power plant system 350 (FIG. 8) and selectively routed to the direct air capture plant 863, and/or via electrical and/or steam inputs from other energy sources.

As described in detail above, the air contactor 781 can receive sodium hydroxide (2NaOH) from the brine processing plant 465 and use the sodium hydroxide as a liquid sorbent to capture carbon dioxide from atmospheric air-outputting a solution of aqueous sodium carbonate (Na₂CO₃) and sodium hydroxide according to equation (5) above. In the illustrated embodiment, the sodium carbonate reaction chamber 1187 is positioned to receive acetic acid (CH₃COOH) and the aqueous solution of sodium carbonate and sodium hydroxide, and is configured to react the acetic acid with the solution to produce (e.g., release, generate, regenerate) gaseous carbon dioxide (CO₂) and sodium acetate (CH₃COONa) according to equations (16) and (17) below:

CH₃COOH+NaOH→CH₃COONₐ+H₂O (16)

CH₃COOH+Na₂CO₃→CH₃COONa+H₂O+CO₂ (17)

The carbon dioxide in the capturing solution generated by the air contactor 781 is released (e.g., regenerated) in gaseous from and can be routed to the compressor 785, which is configured to compress the carbon dioxide into a liquid, solid, and/or gaseous form for storage (e.g., sequestration) and/or use in one or more industrial processes. The resultant sodium acetate can be routed to the chemical processing plant 866 for use in, for example, producing hydrogen as an energy carrier. In some aspects of the present technology, the carbon dioxide can be released from the capturing solution without the use of copious energy typically required by conventional direct air capture processes.

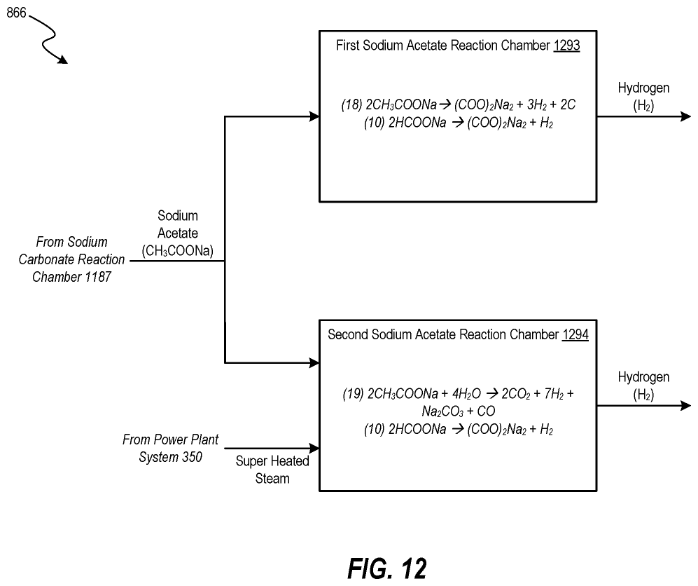

FIG. 12 is a schematic diagram of the chemical processing plant 866 of FIG. 8 configured to utilize sodium acetate produced by the direct air capture plant 863 of FIG. 11 to produce hydrogen in accordance with embodiments of the present technology. In the illustrated embodiment, the chemical processing plant 866 (e.g., sodium acetate processing plant, hydrogen generation plant) includes a first sodium acetate reaction chamber 1293 and a second sodium acetate reaction chamber 1294. The first sodium acetate reaction chamber 1293 and the second sodium acetate reaction chamber 1294 can each operate using electricity and/or steam produced by the power plant system 350 (FIG. 8) and selectively routed to the chemical processing plant 866, and/or via electrical and/or steam inputs from other energy sources.

In some embodiments, the first sodium acetate reaction chamber 1293 is positioned to receive at least a portion of the sodium acetate produced by the sodium carbonate reaction chamber 1187 (FIG. 11) and configured to heat the sodium acetate (e.g., via electricity and/or steam supplied by the power plant system 350 of FIG. 8) to a temperature of about 500 degrees Celsius. Upon heating, the sodium acetate decomposes into sodium formate ((COO)₂Na₂), hydrogen gas (3H₂), and carbon (C) according to equation (18) below:

2CH₃COONa→(COO)₂Na₂+3H₂+2C (18)

The sodium formate can further decompose upon heating to form sodium oxalate (COO)₂Na₂) and hydrogen gas (H₂) according to equation (10) above.

In some embodiments, the second sodium acetate reaction chamber 1294 is positioned to receive at least a portion of the sodium acetate produced by the sodium carbonate reaction chamber 1187 (FIG. 11) and configured to heat the sodium acetate (e.g., via electricity and steam supplied by the power plant system 350 of FIG. 8; via processed super-heated steam from the power plant system 350 of FIG. 8) to a temperature of about 550 degrees Celsius. Upon heating, the sodium acetate decomposes into sodium carbonate (Na₂CO₃), carbon dioxide (2CO₂), carbon monoxide (CO) and hydrogen (7H₂) according to equation (19) below:

2CH₃COONa+4H₂O→2CO₂+7H₂+Na₂CO₃+CO (19)

The sodium oxalate, methane, and/or other chemical byproducts (e.g., sodium oxalate) produced by the first sodium acetate reaction chamber 1293 and/or the second sodium acetate reaction chamber 1294 can be utilized for other industrial processes. For example, the methane produced by the second sodium acetate reaction chamber 1294 can be compressed, separated, and used in a steam-methane reforming (SMR) process to produce additional hydrogen with carbon dioxide recapture according to, for example, any of the direct air capture processes described herein. The produced hydrogen can be used in industrial processes or to, for example, generate electricity to support an energy imbalance market (EIM) as described in U.S. patent application Ser. No. 18/486,971, titled “SMALL MODULAR NUCLEAR REACTOR INTEGRATED ENERGY SYSTEMS FOR IN-SITU, ON-DEMAND HYDROGEN GENERATION AND/OR THE PRODUCTION OF SODIUM FORMATE,” and filed Oct. 13, 2023, which is incorporated by reference herein in its entirety. In some embodiments, the first sodium acetate reaction chamber 1293 and the second sodium acetate reaction chamber 1294 can be combined into a single reaction chamber having, for example, variable reaction temperatures (e.g., between 330-500 degrees Celsius).

Referring to FIGS. 4 and 8, in some embodiments some or all of the sodium hydroxide, hydrogen, chlorine, clean water, carbon dioxide, chemical byproducts, hydrogen, and/or other chemicals produced by the integrated energy systems 460 and/or 860 can be routed for use in other industrial processes and/or for other uses. For example, some or all of these components can be used in various industrial processes to produce sodium formate, hydrogen (e.g., as an energy carrier), hydrochloric acid, and/or the like, as described in, for example, U.S. patent application Ser. No. 18/486,971, titled “SMALL MODULAR NUCLEAR REACTOR INTEGRATED ENERGY SYSTEMS FOR IN-SITU, ON-DEMAND HYDROGEN GENERATION AND/OR THE PRODUCTION OF SODIUM FORMATE,” and filed Oct. 13, 2023, which is incorporated by reference herein in its entirety. Likewise, the power plant system 350 can be additionally or alternatively operably coupled to various industrial processes for producing hydrogen, oxygen, green industrial products, and/or the like, as described in, for example, U.S. patent application Ser. No. 18/116,819, titled “SMALL MODULAR NUCLEAR REACTOR INTEGRATED ENERGY SYSTEMS FOR ENERGY PRODUCTION AND GREEN INDUSTRIAL APPLICATIONS,” and filed Mar. 2, 2023, which is incorporated by reference herein in its entirety.

In some embodiments, the power plant system 350 can be controlled to selectively provide differing amounts of electricity and/or steam to (i) the power grid 461, (ii) the desalination plant 462, (iii) the direct air capture plants 463 and/or 863, and/or (iv) the chemical processing plant 866 based on the demands of the power grid 461. For example, during off-peak hours (e.g., a first demand state of the power grid 461) the power plant system 350 can be controlled/configured to have a first operating state in which the power plant system 350 provides excess electricity and steam to (i) the desalination plant 462 to produce brine and clean water, (ii) the direct air capture plant 463 to capture carbon dioxide from air, and/or (iii) the chemical processing plant 866 to generate hydrogen. During peak hours or other durations of high demand on the power grid 461 (e.g., a second demand state of the power grid 461), the power plant system 350 can be controlled/configured to have a second operating state different than the first operating state in which more or all of the electricity produced by the power plant system 350 is routed from the power plant system 350 to the power grid 461. For example, the desalination plant 462 and/or direct air capture plant 463 can be offline during peak hours and all of the output (e.g., electricity) produced by the power plant system 350 can be routed to the power grid 461.

In some aspects of the present technology, some of nuclear reactors 300 (FIG. 3) of the power plant system 350 can be dynamically switched from producing electricity for routing to the power grid 461 to producing steam for use in the desalination plant 462, the direct air capture plant 463, and/or the chemical processing plant 866. Accordingly, the modularity of the nuclear reactors 300 allows the power plant system 350 to flexibly/dynamically switch the output of electricity and steam from individual ones of the nuclear reactors 300 based on the demands of the integrated energy system 460 (e.g., the power grid 461).

Additionally, one or more of the nuclear reactors 300 can be individually taken offline for servicing, maintenance, refueling, etc., while the remainder of the nuclear reactors 300 can continue to produce steam and/or electricity. Accordingly, the power plant system 350 can continue to provide steam and/or electricity to the power grid 461, the desalination plant 462, the direct air capture plant 463, and/or the chemical processing plant 866—even during servicing, maintenance, refueling, etc. In contrast, conventional nuclear reactor systems must be entirely shut down during such procedures such that neither steam nor electricity are available.

In some aspects of the present technology, the integrated energy systems 460 and 860 can be highly efficient and produce little or no carbon emissions. Indeed, the integrated energy systems 460 and 860 can be carbon negative by operating to remove carbon dioxide from the atmosphere via the direct air capture plant 463.

Referring to FIGS. 4-12, the various components can be combined and/or omitted to form integrated energy systems having different configurations. Moreover, each of the arrows indicating the routing/transfer of steam, electricity, brine, clean water, sodium hydroxide, chemical byproducts, etc., can indicate a portion of the routing of overall production of each component. For example, referring to FIG. 4, the power plant system 350 can route a first portion of the electricity generated by the power plant system 350 to the power grid 461, a second portion of the electricity to the desalination plant 462, a third portion of the electricity to the direct air capture plant 463, and so on. Similarly, with reference to FIG. 10, the chemical processing plant 866 can route a first portion of the sodium oxalate to the first sodium oxalate reaction chamber 1091 and a second portion of the sodium oxalate to the second sodium oxalate reaction chamber 1092, for use in their respective processes.

Moreover, while reference is typically made herein to generating “steam,” the power plant system 350 can be used to produce other gases. For example, other fluids can be fed into the nuclear reactors 300 (FIG. 3) and heated to produce gases other than steam that can be routed to various components of the integrated energy systems.

### III. Additional Examples

The following examples are illustrative of several embodiments of the present technology:

1. An integrated energy system, comprising:
a power plant system including a plurality of nuclear reactors, wherein the power plant system is configured to produce a steam output and an electrical output;
a desalination plant positioned to receive seawater and/or brackish water, wherein the desalination plant is coupled to the power plant system to receive a first portion of the steam output and/or a first portion of the electrical output, and wherein the desalination plant is configured to use the first portion of the steam output and/or the first portion of the electrical output to process the seawater and/or brackish water to produce brine and clean water;
a brine processing plant coupled to the desalination plant to receive the brine from the desalination plant and configured to process the brine to produce sodium hydroxide; and
a direct air capture plant coupled to the brine processing plant to receive the sodium hydroxide from the brine processing plant and coupled to the power plant system to receive a second portion of the steam output and/or a second portion of the electrical output, wherein the direct air capture plant is configured to use the sodium hydroxide and the second portion of the steam output and/or the second portion of the electrical output in a direct air capture process to capture carbon dioxide from atmospheric air.

2. The integrated energy system of example 1 wherein the direct air capture plant comprises an air contactor configured to react the atmospheric air with the sodium hydroxide to produce a solution of sodium carbonate and sodium hydroxide.

3. The integrated energy system of example 2 wherein the direct air capture plant further comprises an evaporator coupled to the air contactor to receive the solution of sodium carbonate and sodium hydroxide, and wherein the evaporator is configured to heat the solution of sodium carbonate and sodium hydroxide to produce solid sodium carbonate.

4. The integrated energy system of example 3 wherein the direct air capture plant further comprises a thermal decomposition chamber coupled to the evaporator to receive the solid sodium carbonate, and wherein the evaporator is configured to heat the solid sodium carbonate to produce gaseous carbon dioxide and sodium oxide.

5. The integrated energy system of example 4 wherein the direct air capture plant further comprises a sodium oxide reaction chamber coupled to the thermal decomposition chamber to receive the sodium oxide, wherein the sodium oxide reaction chamber is configured to react the sodium oxide with water to regenerate sodium hydroxide, wherein the air contactor is coupled to the sodium oxide reaction chamber to receive the regenerated sodium hydroxide, and wherein the air contactor is further configured to react the atmospheric air with the regenerated sodium hydroxide to at least partially produce the solution of sodium carbonate and sodium hydroxide.

6. The integrated energy system of example 2 wherein the direct air capture plant is further configured to receive a carboxylic acid and to react the carboxylic acid with the solution of sodium carbonate and sodium hydroxide to produce gaseous carbon dioxide and a chemical byproduct.

7. The integrated energy system of example 6 wherein the carboxylic acid is formic acid, and wherein the chemical byproduct is sodium formate.

8. The integrated energy system of example 7, further comprising a sodium formate processing plant coupled to the direct air capture plant to receive the sodium formate, wherein the sodium formate processing plant is configured to process the sodium formate to produce hydrogen.

9. The integrated energy system of example 6 wherein the carboxylic acid is acetic acid, and wherein the chemical byproduct is sodium acetate.

10. The integrated energy system of example 9, further comprising a sodium acetate processing plant coupled to the direct air capture plant to receive the sodium acetate, wherein the sodium acetate processing plant is configured to process the sodium acetate to produce hydrogen.

11. The integrated energy system of any one of examples 1-10 wherein the brine processing plant is configured to treat the brine using a Chlor-Alkali Membrane electrolysis process to produce the sodium hydroxide.

12. The integrated energy system of any one of examples 1-11 wherein the power plant system and the desalination plant are positioned local to one another.

13. An integrated energy system, comprising:
a power plant system including a plurality of nuclear reactors, wherein the power plant system is configured to produce a steam output and an electrical output; and
a direct air capture plant coupled to the power plant system to receive at least a portion of the steam output and/or at least a portion of the electrical output, wherein the direct air capture plant is configured to use the portion of the steam output and/or the portion of the electrical output in a direct air capture process to capture carbon dioxide from atmospheric air, and wherein the direct air capture plant comprises—
   an air contactor configured to react the atmospheric air with sodium hydroxide to produce a solution of sodium carbonate and sodium hydroxide;
   an evaporator coupled to the air contactor to receive the solution of sodium carbonate and sodium hydroxide, wherein the evaporator is configured to heat the solution of sodium carbonate and sodium hydroxide to produce solid sodium carbonate; and
   a thermal decomposition chamber coupled to the evaporator to receive the solid sodium carbonate, wherein the thermal decomposition chamber is configured to heat the solid sodium carbonate to produce gaseous carbon dioxide and sodium oxide.

14. The integrated energy system of example 13 wherein the direct air capture plant further comprises a sodium oxide reaction chamber coupled to the thermal decomposition chamber to receive the sodium oxide, wherein the sodium oxide reaction chamber is configured to react the sodium oxide with water to regenerate sodium hydroxide, wherein the air contactor is coupled to the sodium oxide reaction chamber to receive the regenerated sodium hydroxide, and wherein the air contactor is further configured to react the atmospheric air with the regenerated sodium hydroxide to at least partially produce the solution of sodium carbonate and sodium hydroxide.

15. An integrated energy system, comprising:
a power plant system including a plurality of nuclear reactors, wherein the power plant system is configured to produce a steam output and an electrical output; and
a direct air capture plant coupled to the power plant system to receive at least a portion of the steam output and/or at least a portion of the electrical output, wherein the direct air capture plant is configured to use the portion of the steam output and/or the portion of the electrical output in a direct air capture process to capture carbon dioxide from atmospheric air, and wherein the direct air capture plant comprises
   an air contactor configured to react the atmospheric air with sodium hydroxide to produce a solution of sodium carbonate and sodium hydroxide; and
   a sodium carbonate reaction chamber coupled to the air contactor to receive the solution of sodium carbonate and sodium hydroxide, wherein the sodium carbonate reaction chamber is configured to react a carboxylic acid with the solution of sodium carbonate and sodium hydroxide to produce gaseous carbon dioxide and a chemical byproduct.

16. The integrated energy system of example 15 wherein the carboxylic acid is formic acid, and wherein the chemical byproduct is sodium formate.

17. The integrated energy system of example 16, further comprising a sodium formate processing plant coupled to the direct air capture plant to receive the sodium formate, wherein the sodium formate processing plant is configured to process the sodium formate to produce hydrogen.

18. The integrated energy system of example 15 wherein the carboxylic acid is acetic acid, and wherein the chemical byproduct is sodium acetate.

19. The integrated energy system of example 18, further comprising a sodium acetate processing plant positioned coupled to the direct air capture plant to receive the sodium acetate, wherein the sodium acetate processing plant is configured to process the sodium acetate to produce hydrogen.

20. The integrated energy system of any one of examples 15-19 wherein the direct air capture plant is coupled to the power plant system to receive a first portion of the steam output and/or a first portion of the electrical output, and further comprising a chemical processing plant coupled to the direct air capture plant to receive the chemical byproduct and coupled to the power plant system to receive a second portion of the steam output and/or a second portion of the electrical output, wherein the chemical processing plant is configured to use the second portion of the steam output and/or the second portion of the electrical output to process the chemical byproduct to produce hydrogen.

### IV. CONCLUSION

All numeric values are herein assumed to be modified by the term about whether or not explicitly indicated. The term about, in the context of numeric values, generally refers to a range of numbers that one of skill in the art would consider equivalent to the recited value (e.g., having the same function and/or result). For example, the term about can refer to the stated value plus or minus ten percent. For example, the use of the term about 100 can refer to a range of from 90 to 110, inclusive. In instances in which the context requires otherwise and/or relative terminology is used in reference to something that does not include, or is not related to, a numerical value, the terms are given their ordinary meaning to one skilled in the art.

The above detailed description of embodiments of the present technology are not intended to be exhaustive or to limit the technology to the precise forms disclosed above. Although specific embodiments of, and examples for, the technology are described above for illustrative purposes, various equivalent modifications are possible within the scope of the technology, as those skilled in the relevant art will recognize. For example, although steps may be presented in a given order, in other embodiments, the steps may be performed in a different order. The various embodiments described herein may also be combined to provide further embodiments.

From the foregoing, it will be appreciated that specific embodiments of the technology have been described herein for purposes of illustration, but well-known structures and functions have not been shown or described in detail to avoid unnecessarily obscuring the description of the embodiments of the technology. Where the context permits, singular or plural terms may also include the plural or singular term, respectively.

As used herein, the phrase and/or as in A and/or B refers to A alone, B alone, and A and B. Additionally, the term comprising is used throughout to mean including at least the recited feature(s) such that any greater number of the same feature and/or additional types of other features are not precluded. It will also be appreciated that specific embodiments have been described herein for purposes of illustration, but that various modifications may be made without deviating from the technology. Further, while advantages associated with some embodiments of the technology have been described in the context of those embodiments, other embodiments may also exhibit such advantages, and not all embodiments need necessarily exhibit such advantages to fall within the scope of the technology. Accordingly, the disclosures and associated technologies can encompass other embodiments not expressly shown or described herein.

I/We claim:

1. An integrated energy system, comprising:
a power plant system including a plurality of nuclear reactors, wherein the power plant system is configured to produce a steam output and an electrical output;
a desalination plant positioned to receive seawater and/or brackish water, wherein the desalination plant is coupled to the power plant system to receive a first portion of the steam output and/or a first portion of the electrical output, and wherein the desalination plant is configured to use the first portion of the steam output and/or the first portion of the electrical output to process the seawater and/or brackish water to produce brine and clean water;
a brine processing plant coupled to the desalination plant to receive the brine from the desalination plant and configured to process the brine to produce sodium hydroxide; and
a direct air capture plant coupled to the brine processing plant to receive the sodium hydroxide from the brine processing plant and coupled to the power plant system to receive a second portion of the steam output and/or a second portion of the electrical output, wherein the direct air capture plant is configured to use the sodium hydroxide and the second portion of the steam output and/or the second portion of the electrical output in a direct air capture process to capture carbon dioxide from atmospheric air.

2. The integrated energy system of claim 1 wherein the direct air capture plant comprises an air contactor configured to react the atmospheric air with the sodium hydroxide to produce a solution of sodium carbonate and sodium hydroxide.

3. The integrated energy system of claim 2 wherein the direct air capture plant further comprises an evaporator coupled to the air contactor to receive the solution of sodium carbonate and sodium hydroxide, and wherein the evaporator is configured to heat the solution of sodium carbonate and sodium hydroxide to produce solid sodium carbonate.

4. The integrated energy system of claim 3 wherein the direct air capture plant further comprises a thermal decomposition chamber coupled to the evaporator to receive the solid sodium carbonate, and wherein the evaporator is configured to heat the solid sodium carbonate to produce gaseous carbon dioxide and sodium oxide.

5. The integrated energy system of claim 4 wherein the direct air capture plant further comprises a sodium oxide reaction chamber coupled to the thermal decomposition chamber to receive the sodium oxide, wherein the sodium oxide reaction chamber is configured to react the sodium oxide with water to regenerate sodium hydroxide, wherein the air contactor is coupled to the sodium oxide reaction chamber to receive the regenerated sodium hydroxide, and wherein the air contactor is further configured to react the atmospheric air with the regenerated sodium hydroxide to at least partially produce the solution of sodium carbonate and sodium hydroxide.

6. The integrated energy system of claim 2 wherein the direct air capture plant is further configured to receive a carboxylic acid and to react the carboxylic acid with the solution of sodium carbonate and sodium hydroxide to produce gaseous carbon dioxide and a chemical byproduct.

7. The integrated energy system of claim 6 wherein the carboxylic acid is formic acid, and wherein the chemical byproduct is sodium formate.

8. The integrated energy system of claim 7, further comprising a sodium formate processing plant coupled to the direct air capture plant to receive the sodium formate, wherein the sodium formate processing plant is configured to process the sodium formate to produce hydrogen.

9. The integrated energy system of claim 6 wherein the carboxylic acid is acetic acid, and wherein the chemical byproduct is sodium acetate.

10. The integrated energy system of claim 9, further comprising a sodium acetate processing plant coupled to the direct air capture plant to receive the sodium acetate, wherein the sodium acetate processing plant is configured to process the sodium acetate to produce hydrogen.

11. The integrated energy system of claim 1 wherein the brine processing plant is configured to treat the brine using a Chlor-Alkali Membrane electrolysis process to produce the sodium hydroxide.

12. The integrated energy system of claim 1 wherein the power plant system and the desalination plant are positioned local to one another.

13. An integrated energy system, comprising:
a power plant system including a plurality of nuclear reactors, wherein the power plant system is configured to produce a steam output and an electrical output; and
a direct air capture plant coupled to the power plant system to receive at least a portion of the steam output and/or at least a portion of the electrical output, wherein the direct air capture plant is configured to use the portion of the steam output and/or the portion of the electrical output in a direct air capture process to capture carbon dioxide from atmospheric air, and wherein the direct air capture plant comprises—
an air contactor configured to react the atmospheric air with sodium hydroxide to produce a solution of sodium carbonate and sodium hydroxide;
an evaporator coupled to the air contactor to receive the solution of sodium carbonate and sodium hydroxide, wherein the evaporator is configured to heat the solution of sodium carbonate and sodium hydroxide to produce solid sodium carbonate; and
a thermal decomposition chamber coupled to the evaporator to receive the solid sodium carbonate, wherein the thermal decomposition chamber is configured to heat the solid sodium carbonate to produce gaseous carbon dioxide and sodium oxide.

14. The integrated energy system of claim 13 wherein the direct air capture plant further comprises a sodium oxide reaction chamber coupled to the thermal decomposition chamber to receive the sodium oxide, wherein the sodium oxide reaction chamber is configured to react the sodium oxide with water to regenerate sodium hydroxide, wherein the air contactor is coupled to the sodium oxide reaction chamber to receive the regenerated sodium hydroxide, and wherein the air contactor is further configured to react the atmospheric air with the regenerated sodium hydroxide to at least partially produce the solution of sodium carbonate and sodium hydroxide.

15. An integrated energy system, comprising:
a power plant system including a plurality of nuclear reactors, wherein the power plant system is configured to produce a steam output and an electrical output; and
a direct air capture plant coupled to the power plant system to receive at least a portion of the steam output and/or at least a portion of the electrical output, wherein the direct air capture plant is configured to use the portion of the steam output and/or the portion of the electrical output in a direct air capture process to capture carbon dioxide from atmospheric air, and wherein the direct air capture plant comprises—
an air contactor configured to react the atmospheric air with sodium hydroxide to produce a solution of sodium carbonate and sodium hydroxide; and
a sodium carbonate reaction chamber coupled to the air contactor to receive the solution of sodium carbonate and sodium hydroxide, wherein the sodium carbonate reaction chamber is configured to react a carboxylic acid with the solution of sodium carbonate and sodium hydroxide to produce gaseous carbon dioxide and a chemical byproduct.

16. The integrated energy system of claim 15 wherein the carboxylic acid is formic acid, and wherein the chemical byproduct is sodium formate.

17. The integrated energy system of claim 16, further comprising a sodium formate processing plant coupled to the direct air capture plant to receive the sodium formate, wherein the sodium formate processing plant is configured to process the sodium formate to produce hydrogen.

18. The integrated energy system of claim 15 wherein the carboxylic acid is acetic acid, and wherein the chemical byproduct is sodium acetate.

19. The integrated energy system of claim 18, further comprising a sodium acetate processing plant positioned coupled to the direct air capture plant to receive the sodium acetate, wherein the sodium acetate processing plant is configured to process the sodium acetate to produce hydrogen.

20. The integrated energy system of claim 15 wherein the direct air capture plant is coupled to the power plant system to receive a first portion of the steam output and/or a first portion of the electrical output, and further comprising a chemical processing plant coupled to the direct air capture plant to receive the chemical byproduct and coupled to the power plant system to receive a second portion of the steam output and/or a second portion of the electrical output, wherein the chemical processing plant is configured to use the second portion of the steam output and/or the second portion of the electrical output to process the chemical byproduct to produce hydrogen.
